(19) United States
(12) Patent Application Publication
(10) Pub. No.: US 2024/0169355 A1
(43) Pub. Date: May 23, 2024

(54) SETTLEMENT CARD HAVING LOCKED-IN CARD SPECIFIC MERCHANT AND RULE-BASED AUTHORIZATION FOR EACH TRANSACTION

(71) Applicant: KEO WORLD, INC., Miami, FL (US)

(72) Inventors: Paolo FIDANZA, Miami, FL (US); Andres ROSSO, Bogota (CO); Juan Gabriel SILVA, Bogota (CO); Anastasia REYES MCALLISTER, Bogota (CO)

(21) Appl. No.: 18/508,280

(22) Filed: Nov. 14, 2023

Related U.S. Application Data
(60) Provisional application No. 63/384,101, filed on Nov. 17, 2022.

(51) Int. Cl. G06Q 20/40

(52) U.S. Cl. CPC G06Q 20/405

(57) ABSTRACT

A settlement card system includes a settlement card that is locked for authorized use with a single card specific merchant. A first computing system is operated by the card issuer and determines a transaction monetary limit and customer payment terms that differ for each subsequent, single transaction by the customer with the card specific merchant. A second computing system forwards the authorization request to the first computing system, which determines if the transaction is within the monetary limit determined for the customer, and if no, reject the transaction, if yes, accept the transaction and determine customer payment terms for that transaction. A third computing system makes payment to the authorized merchant for the transaction after receiving a payment authorization from the first computing system. The first computing system transfers a payment to the third computing system in the amount of the transaction.

### PRIORITY APPLICATION

This application is based upon provisional Application No. 63/384,101 filed Nov. 17, 2022, the disclosure which is hereby incorporated by reference in its entirety.

### FIELD OF THE INVENTION

The present invention relates to the field of transaction cards, and more particularly, this invention relates to a settlement card having a locked-in card specific merchant for use.

### BACKGROUND OF THE INVENTION

There are four primary types of transaction cards in use today in both private and commercial settings. A prepaid transaction card has a set monetary value that may be purchased, such as a restaurant card or a specific transaction card used for an internet purchase on Amazon and similar websites. The prepaid transaction card may be as little as a few dollars to as much as hundreds or thousands of dollars and reflects the amount of money the user may have purchased for the card or deposited on the card from a bank or merchant. Once the monetary value on the card is used, the prepaid transaction card is usually voided and no longer usable.

A debit card, on the other hand, reflects the amount of money in an account or wallet, such as a bank account. A debit card may be used at many locations, and a user's bank account debited the amount of the purchase. The user may also replenish their account and the debit card may be repeatedly used. The debit card is limited only by the amount of money reflected in the bank account.

A credit card is a transaction card that is loaded with an amount of credit, which a user must repay over a pre-defined period. A credit card is subject to the constant transaction rules with defined payment terms and penalties incurred when payment is not made. For example, the credit card may be used 100 times and each transaction will have the same rules. A loyalty transaction card, on the other hand, reflects use at a merchant and accumulates points, such as continuing to purchase goods at a grocery store and accumulating points on their grocery loyalty card. A prepaid transaction card, debit card, and credit card are usually regulated with strict state and/or federal regulations and have strict fraud guidelines regulating use of the cards in a commercial marketplace.

There are no transaction cards that meet the needs of large corporate clients that may require large purchases, such as one million pounds of concrete. Often normal transaction cards are not used since many large corporate client purchases involve wire transfers. Sometimes a corporate client may desire to purchase a specific but large amount of product or products from a specific authorized supplier. Because of those types of purchases and the fluidity of the marketplace, the rules for each transaction may have to change for each specific corporate client with each specific transaction. For example, the intent, the payment terms, and other transaction details may need to change for each new specific, single transaction with a specific merchant. Normal transaction cards do not meet this need and that need has gone unfulfilled.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

A settlement card system may comprise a settlement card issued by a card issuer, assigned a specific card customer, locked for authorized use with a single card specific merchant, and having stored settlement card data identifying a) the respective customer to which the settlement card is assigned, b) the card issuer, c) the card specific merchant, and d) a card payment service of the settlement card. A first computing system operated by the card issuer may be configured to determine a transaction monetary limit and customer payment terms that differ for each subsequent, single transaction by the customer with the card specific merchant. A second computing system may be configured to receive from the card specific merchant the stored card data of the settlement card and an authorization request for approval of the transaction when the customer presents its settlement card to the card specific merchant to effect the transaction. The second computing system may be configured to identify the card issuer and customer from the stored card data and forward the authorization request to the first computing system. The first computing system may be configured to determine if the transaction is within the monetary limit determined for the customer, and if no, reject the transaction, if yes, accept the transaction and determine customer payment terms for that transaction. A third computing system may be operated by the card payment service. The third computing system may be configured to make payment to the authorized merchant for the transaction after receiving a payment authorization from the first computing system, and in response, the first computing system may transfer a payment to the third computing system in the amount of the transaction.

The third computing system may comprise a server network operated by the card payment service. The first computing system may comprise a plurality of servers in a cloud network forming a machine learning network as an artificial neural network. The customer may make payment to the first computing system for the transaction based upon payment terms determined by the first computing system for that specific, single transaction. The settlement card may comprise a virtual settlement card.

In an example, the first computing system may be configured to pull past financial transaction data and associated business data for the card customer from public and private data sources and extract customer data features as decision values. The first computing system may further comprise a rules engine configured to apply a machine learning approval model as a set of rules to the decision values. The first computing system may update decision values and apply the machine learning model and a set of new rules to the updated decision values and determine a new customer monetary limit and payment terms for the subsequent, single transaction by the customer. The rules engine may comprise a reasoner inference engine that optimizes each set of new rules by applying a forward chaining model to the decision values based upon new inferences and applying an expert system as a backward chaining model to the decision values. The reasoner inference engine may establish a syntax tree for each set of new rules. The first computing system may comprise at least one cache configured to cache the syntax tree that is updated each time the first computing system applies the machine learning approval model and set of new rules to updated decision values.

The associated business data for the customer may comprise a) behavior variables related to business transactions of the customer, b) social characteristics of the customer when interacting with the public, and c) business relationships of the customer with different companies. The first computing system may comprise a plurality of servers in a cloud network forming a machine learning network as an artificial neural network. The first computing system may also comprise a non-relational database that stores business rules parameterized in a structured JSON file. The non-relational database may be mounted on a database hosting service. The settlement card may comprise a virtual settlement card.

### BRIEF DESCRIPTION OF THE DRAWINGS

Other objects, features and advantages of the present invention will become apparent from the Detailed Description of the invention which follows, when considered in light of the accompanying drawings in which:

FIG. 1A is a high-level block diagram of the settlement card system.

FIG. 1B is a schematic diagram of a settlement card.

FIG. 2 is a schematic diagram showing the settlement card usage in an example with a cardholder and merchant.

FIG. 3 is another schematic diagram showing financial processes using the settlement card.

FIG. 4 is a block diagram showing a process flow modeling for the settlement card.

FIG. 5 is a block sequence diagram showing the settlement card creation.

FIG. 6 is a sequence diagram for the settlement card and process flow modeling.

FIG. 7 a sequence diagram for the on boarding of the settlement card.

FIG. 8 is a sequence diagram of the underwriting process of the settlement card.

FIG. 9 is a diagram showing the rule engine use cases for a settlement card transaction.

FIG. 10 is a block diagram of the module architecture.

FIG. 11 is sequence diagram showing the rule engine module relative to the rule editor and process flow modeling.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

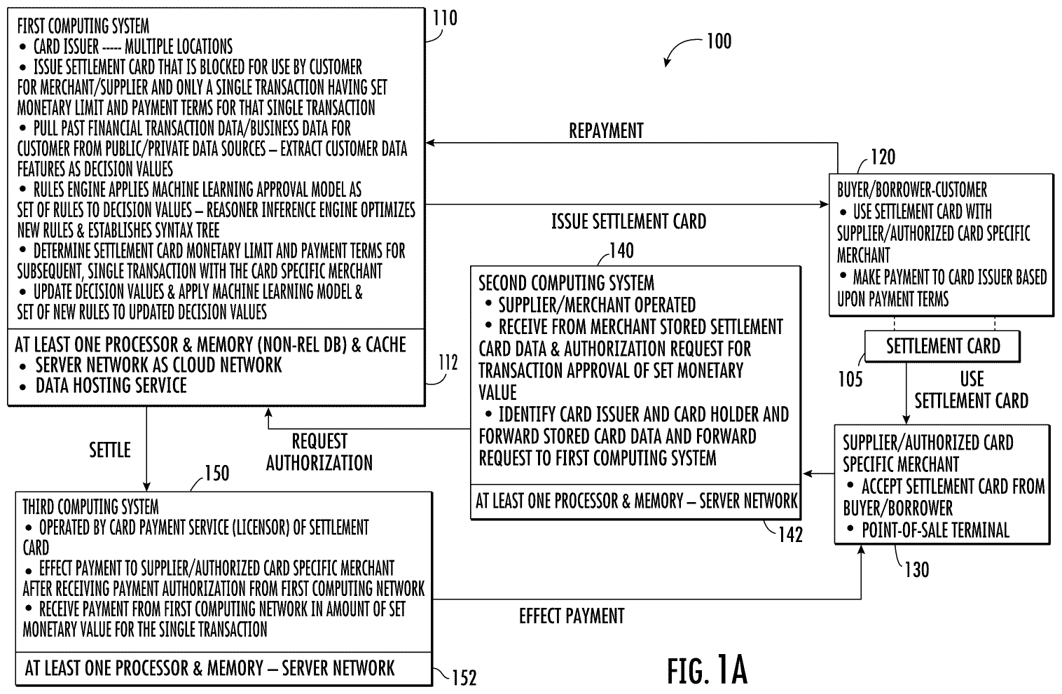

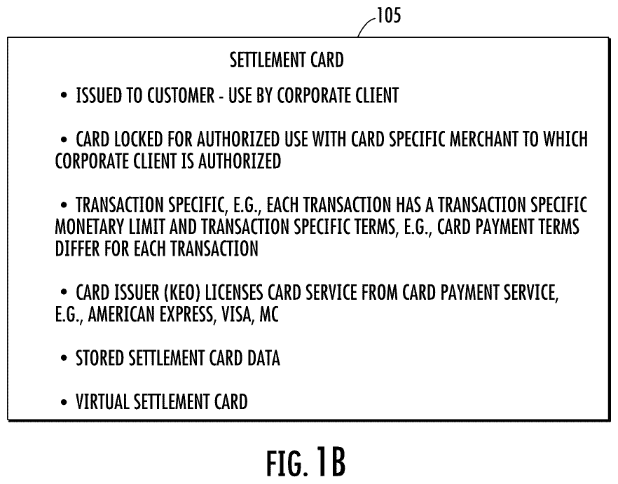

Referring now to FIG. 1A, there is illustrated a block diagram of the settlement card system shown generally at 100. In this example, a plurality of settlement cards 105 may be used within the system 100. Each settlement card 105 as shown in FIG. 1B is assigned, and thus, belongs to a specific card customer 120 as a buyer or borrower, for example, a corporate client and may be issued by a single card issuer operating a first computing system 110 that may include at least one processor and memory, including a cache, shown at 112 and may operate as a server network or cloud network with a data hosting service. Each settlement card 105 is locked for authorized use with an authorized card specific merchant 130, such as shown in FIG. 1A, as a supplier. Each settlement card 105 has stored card data identifying: a) the respective customer to which the settlement card is assigned, b) the card issuer, c) the card specific merchant 130, and d) the card payment service as the licensor of the settlement card. For example, the licensor of the settlement card 105 may be a card payment service, such as American Express, Visa, MasterCard, or Discover. A customer 120, such as a corporate client, may use its settlement card 105 only for those card specific merchants 130 for which it is authorized. For example, the customer 120 may need to purchase one million pounds of concrete and the settlement card 105 may only be used for a specific concrete supplier as an authorized card specific merchant 130 and only for a specific purchase amount at this time.

The first computing system 110 is operated by the card issuer, and in the example as explained in further detail below, may be operated by the card issuer such as KEO World of Miami, Florida. The first computing system 110 is operated by the card issuer, such as KEO World, and may determine a transaction customer payment terms monetary limit and customer payment terms that differ for each subsequently single transaction by the customer with the card specific merchant may be configured to pull past financial transaction data and associated business data for the card customer 120 from public and private data sources and extract customer data features as decision values. A rules engine is configured to apply a machine learning approval model as a set of rules to the decision values and determine a settlement card transaction monetary limit and customer payment terms that differ for each subsequent single transaction by the customer with the card specific merchant. This occurs in an example for each transaction. The first computing system 110 updates decision values and applies the machine learning model and a set of new rules to the updated decision values and determine a new customary monetary limit and payment terms for the subsequent single transaction by the customer 120. The settlement card 105 may be a virtual settlement card. In this example, the first computing system 110 may include a first host server, such as located in the United States, and a second host server, such as located off-shore such as Puerto Rico.

A second computing system 140 may be a supplier or merchant operated network that works in association with the authorized specific merchant 130 having a point-of-sale (POS) terminal, for example. The second computing system 140 may include at least one processor and memory and incorporate a server network 142 as the example merchant network receives from an authorized card specific merchant 130 the stored card data of the settlement card 105 and an authorization request for approval of the transaction when the customer presents its settlement card to the authorized card specific merchant to effect the transaction. The second computing system 140 identifies the card issuer and customer from the stored card data and forwards the authorization request to the first computing system 110, which determines if the transaction is within the monetary limit determined for the customer, and if no, reject the transaction, if yes, accept the transaction and determine customer payment terms for that transaction.

A third computing system 150 is operated by a card payment service such as a licensor of the settlement card 105, e.g., American Express, and makes payment to the authorized card specific merchant 130 for the single transaction after receiving a payment authorization from the first computing system 110. In response, the first computing system 100 transfers a payment to the third computing system 150 in the amount of the transaction as a set monetary value.

In an example, the first computing system 110 updates decision values and applies the machine learning model and a set of new rules to the updated decision values for each new specific, single transaction with the specific authorized merchant to determine a new settlement card monetary limit and payment terms for a new specific, single transaction. The customer 120 makes a payment to the first computing system 110 for the transaction based upon payment terms determined by the first computing system for that specific, single transaction.

In an example, the third computing system 150 may include at least one processor and memory that may be operative as a server network 152 operated by the card network. The third computing system 150 may be operated by the card payment service such as a credit card company in a non-limiting example. The card payment service operating the third computing system may license the settlement card 105 that is issued by the operator of the first computing system 110, e.g., KEO network. The server network 152 may be part of a cloud-based network and include one or more processors and memories at a specific location or multiple locations, such as a main business or enterprise location such as two data hosting or host server locations.

In an example, the rules engine operated by the first computing system 110 may include a reasoner inference engine that optimizes each set of new rules by applying a forward training model to the decision values based upon new inferences and applying an expert system as a backward chaining model to the decision values. The reasoner inference engine may establish a syntax tree for each set of new rules. The first computing system 110 may include at least one cache as part of the at least one processor and memory as a server network 112 to cache the syntax tree that is updated each time the first computing system 110 applies the machine learning approval model and set of new rules to updated decision values.

The associated business data for each corporate client may include: a) behavior variables related to business transactions of the respective customer 120, b) social characteristics of the customer when interacting with the public, and c) business relationships of the customer with different companies. The first computing system 110 may include at least one processor and memory, including a non-relational database with a cache and formed in an example as a plurality of servers in a cloud network 112 and forming a machine learning network as an artificial neural network. In an example, the first computing system 110 with its processing and network 112 may include its non-relational database that stores business rules parameterized in a structured JSON file. This non-relational database may be mounted on a database hosting service, for example.

The settlement card system 100 provides Buy Now, Pay Later (BNPL) settlement card 105 advantages. In an example, the first computing system 100 could include a Puerto Rico and US location formed as part of the server network 112. When the customer 120 as a corporate client as a borrower-buyer repays the KEO network operating the first computing system 100, it is possible to fund payments directly to a Puerto Rico branch account in Miami, Florida for the amount of the purchase plus a finance charge retained by the Puerto Rico branch account. It is possible that the Puerto Rico office may maintain a bank account in Miami, Florida, and a separate bank account in Puerto Rico in which disbursement of payments to settle with AmEx operating the third computing system 150 for BNPL purchases made by US customer 120 as buyers-borrowers may be sent by the KEO network operating the first computing system 110 from the Miami account to the Puerto Rico account. Payment settlements such as with the “AmEx” settlement card 100 for such BNPL purchases may be sent by KEO operating the first computing system 110 to AmEx operating the second computing system 150 from the Puerto Rico account. Repayments from each customer 120 as the borrower-buyer may be collected into the Miami bank account.

Customers 120 as corporate clients may access working capital credit lines and pay their suppliers as authorized card specific merchants 130 using the settlement card 105 and the settlement card system 100. Credit lines for a specific settlement card 105 are tailor-made according to the needs of each customer 120 as an example corporate client. The settlement card system 100 via the KEO network operating the first computing system 110 may set specific financial conditions with unique rates and terms for each customer 120 as corporate client per each transaction. The settlement card 105 may be loaded with working capital credit lines.

The settlement card 105 is not a credit card and is not a prepaid transaction card, but is a novel and new type of transaction card as a settlement card that allows a specific transaction to an authorized card specific merchant 130 with new rules such as payment terms applied per transaction. New rules attach to each new transaction and operated via the rules engine.

The settlement card 105 is locked only for the pre-approved suppliers, which may be only one supplier. A customer 130 as a corporate client may use its funds to pay the approved suppliers or suppliers in some cases. Once the settlement card 105 is used, the supplier as the authorized card specific merchant 130 may receive the payment and confirmation immediately via the second computing system 150, which may be operated by the institutional financial network as a card payment service.

The working capital credit lines for the settlement card 105 allow the customers 120 such as corporate clients to transact more, better trace their payments, and have greater control over their invoices. In the description as follows, working capital may be that money that a customer 120 as a company has available to meet their current, short-term obligations. Their credit line may be a revolving loan that a company as the borrower may access on demand to meet their obligations. The Bank Identification Number (BIN) may be applied to every settlement card 105, which contains a BIN, e.g., typically the first four to six starting numbers on an institution-issued card, such as in an example, American Express.

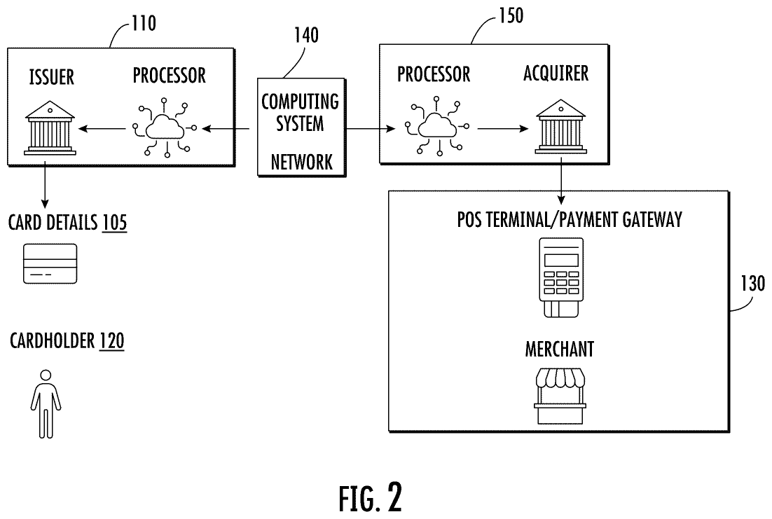

The card issuer (FIG. 2) may correspond to an issuing bank or other institution, for example, the cardholder's (customer 120) lender, which may operate the first computing system 110 as the KEO network. This first computing system 110 operated by the KEO network issues customer 120 as the client a settlement card 105 and manages the account, fees and interest rates. An acquirer may operate as an acquiring institution that processes payments on behalf of a card specific merchant 130, such as part of the third computing system 150, and cooperate with a point-of-sale terminal and any associated servers or processors of the second computing system 140. The acquirer as part of the third computing system 150 may allow merchants 130 to accept settlement card payments. The second computing system 140 may operate as a payment network and an association of member institutions that enable the payment transaction between the merchant 130 and the cardholder as the customer 120.

A sales team, such as part of the KEO network and its first computing system 110, may be responsible for customer acquisition. A first step may be to onboard a customer 120 as a corporate client and perform KYC (know-your-client) and underwriting. Once the customer credit line is approved by the first computing system 110 for the initial transaction and its payment terms, the KEO network operating the first computing system issues the settlement card 105 loaded with the one-time credit line for the single transaction. The customer 120 as a corporate client may use this settlement card 105 to pay its supplier as the authorized card specific merchant 130.

Once the customer 140 uses its settlement card 105 to pay an invoice, a loan is created in the KEO network and first computing system 110, and the customer can view the loan details by accessing a customer portal in the first computing system via a handheld device or computer terminal, for example. It is possible the customer 120 in this example can have multiple loans at the same time as long as the customer does not exceed the credit line. However, each new single transaction may have the credit line and payment terms modified since a set of new rules are applied by the rules engine at the first computing system 110. The customer 120 can pay back the KEO network its loan by wire and include a payment reference. Once the payment is received, the KEO network operating the first computing system 110 closes the loan and updates the credit line, which may occur when the customer 120 as the corporate client presents its settlement card 105 to the new card specific supplier 130 for a new transaction.

In an example, the KEO network operating the first computing system 110 has an issuer card franchise, such as an American Express franchise, but any settlement cards 105 may be used and replicated via licenses with VISA, Mastercard, or other card network as a card payment service. The KEO network issues settlement cards 105 for each customer 120 as a corporate client. These settlement cards 105 are locked so they can only be used with specific suppliers as authorized card specific merchants 130. Once the corporate client credit line is approved, the settlement card 105 is loaded and the customer 120 can use it to pay its authorized suppliers for a single transaction. New rules are then applied for the subsequent transaction and the process continues.

In a transaction, the second computing system 140 may identify the card issuer as the KEO network of the first computing system 110 by looking at the BIN. Once this network as the second computing system 140 identifies the card issuer, the transaction is sent to the first computing system 110 as the KEO network and its network servers and processors 112. The KEO network as the first computing system 110 performs validations to approve a transaction. The working capital credit line should cover the transaction. The settlement card 105 details should be correct and the transaction should not violate any fraud parameter. Once these validations take place, the transaction is approved and the supplier as the authorized card specific merchant 130 receives the payment, and the KEO network operating the first computing system 110 may create a loan. Once a transaction is approved, a loan is created and the working capital credit line may decrease.

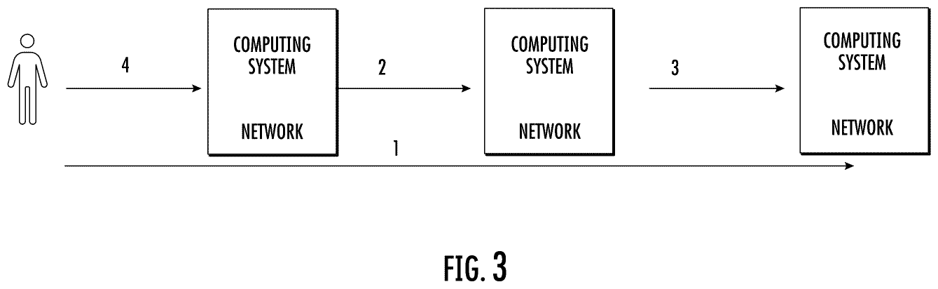

An example of the network cash flow is now explained relative to FIG. 3 with basic computing systems as part of networks illustrated. As shown in the diagram, the sequence corresponds to: 1) the customer 120 as the corporate client pays its supplier as the authorized card specific merchant 130 and no money flow is involved; 2) the network debits the KEO network bank account with the amount of the transaction minus an interchange fee; 3) the network through the card payment service of the third computing system 150 pays the supplier the transaction amount and applied merchant discount rate; and 4) the customer 120 as the corporate client pays back to the KEO network as the first computing system 110 the capital plus interest.

There now follows a technical description of the model for the settlement card transaction flow. Each stage may be modeled with its corresponding states using a finite state machine (FSM), where each stage is a state in the machine and each instance in the machine can be in exactly one of a finite number of states at any given time. The state changes in the FSM are transitions and are driven by the data inputs and conditions coded in the FSM. The outputs in each stage are primarily the inputs for the next stage.

There are advantages of modeling using a FSM approach. There is flexibility because to add new steps, an additional stage is added with an additional state. The inputs are updated to map the new stage output for the desired input in the next stage. This feature gives flexibility for the development process and reduces the effort to test the overall FSM.

There is the advantage of predictability because by using an FSM, the developed product can only transition into a restricted number of states. As a result, instance tracking has less uncertainty. There is also the advantage of familiarity because when working on an updated version, using standard language as FSM methodology allows for a quicker understanding and modeling.

There is the advantage of reliability because any instance can only be active in a given state at any one time, which reduces the chance of unforeseen errors or unexpected behavior in the settlement card system 100. There is also the advantage of safety because it becomes easier to manage the input/outputs on the settlement card system 100 to prevent or manage undesirable behaviors for a running instance. Interfering with the FSM reduces the impact of any issue that arises. Additionally, there is the advantage of monitoring because any running instance in the FSM can be easily monitored and alerts are easy to raise. There is also the advantage of analytics because each FSM produces data that can be collected, stored, and analyzed to identify bottlenecks, stage owners and other factors in order to optimize the FSM.

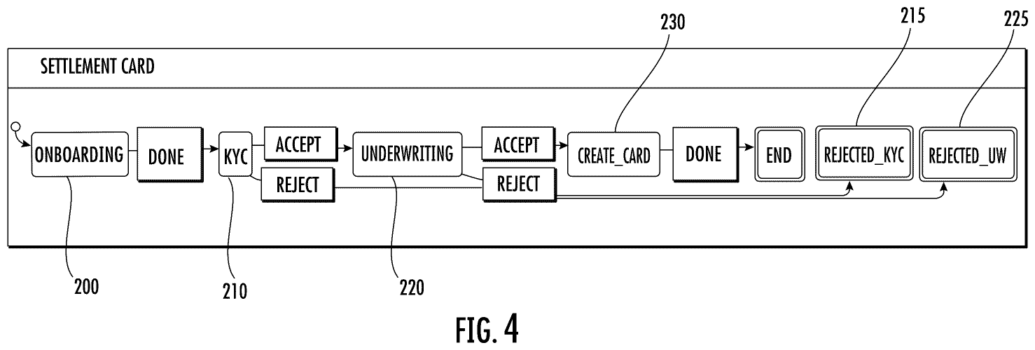

Referring now to FIG. 4, there is illustrated FSM modelling for the settlement card 105. The stages are depicted in FIG. 4, which correspond to sub-processes that are later explained in detail below. The process starts with gathering enough information to enroll the user as a customer as a corporate client in the settlement card system. An identity validation pursuant to know-your-client (KYC) guidelines may be carried out. If the validation is successful, a credit underwriting assessment may be performed based on the customer's financial information. The settlement card 105 is created with the credit line for a specific transaction for a specific supplier 130 as defined in the previous stage. The flow has alternative paths in case the KYC or underwriting sub-processes fail.

A more detailed description of the sub-processes now follows. After onboarding 200, a KYC stage 210 may exist in order to confirm the identity of the customer's organizations and ensure that the customer acts legally. For that reason, a KYC process is performed to validate the identity of the customer, avoid money laundering, and prevent a failure to comply with regulatory requirements, which can lead to a loss of reputation. The KYC process is also seen as an opportunity to understand the new customer as a customer, identify their needs and behaviors, create customized products, improve behaviors, and improve customer relationships. This process may use third party providers to perform actions that are part of the overall FSM or use the preferred KEO network as part of the settlement. The KYC may be rejected 215 by the card system 100.

An underwriting stage 220 may exist where an automatic financial risk assessment and indebtedness capacity may be carried out to define the amount of money for the settlement card 105 for an initial transaction for a card specific merchant 130. Otherwise, the underwriting is rejected 225. The credit approval process may gather all the necessary information to evaluate the credit application and decide if it is approved by analyzing financial health and the settlement card 105 created 230. The credit line is applied to the settlement card 105 for an initial transaction. A credit score process uses machine learning and expert knowledge to analyze available data using statistical approaches as explained in greater detail below.

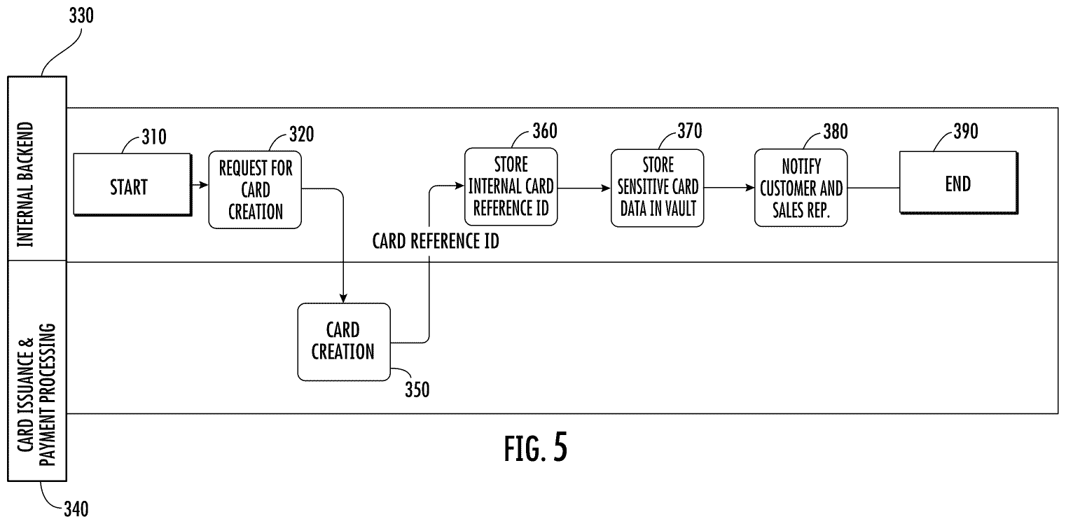

A card creation stage may start 310 by a request card creation 320 as is shown in FIG. 5, at the internal back end 330 of the first computing system 110. This request is forwarded to a card issuance and payment processing module 340 that may be part of the first computing system 110 with related settlement card parameters. Once the settlement card 105 is created 350, an internal reference number is generated and stored 360. The sensitive data, for example, PAN, CVV, Exp. Date, is stored 370 in a security enhanced vault as part of a specific database preferably at the first computing system 110. The data can be accessed when necessary. A final step may be to notify 380 the customer 120 about the new settlement card 105, and in addition, any sales representative that may have been involved with the customer and the KEO network operating the first computing network. As noted before, the settlement card 105 may be a virtual card. The process ends 390.

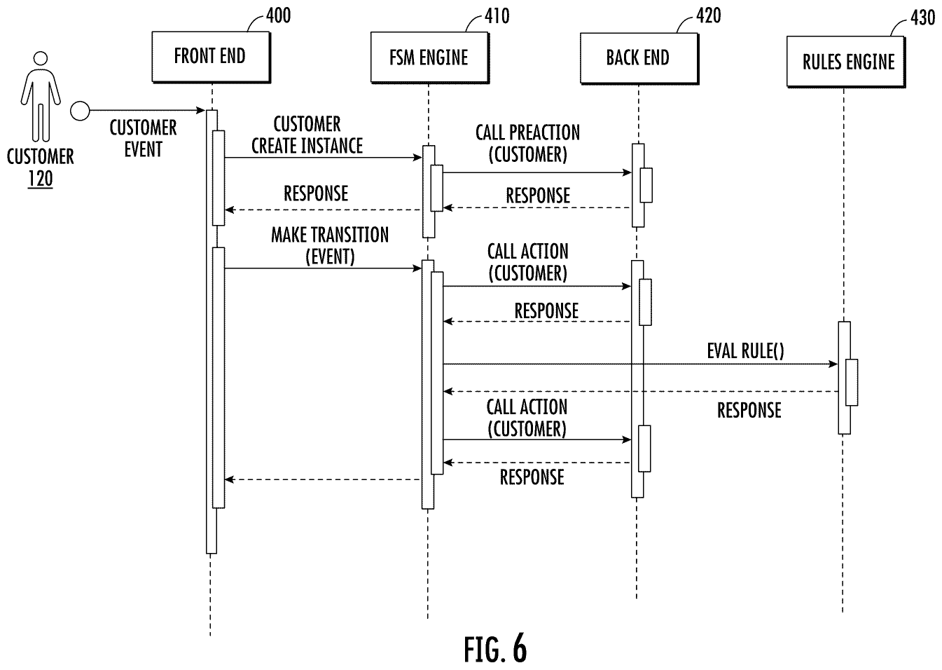

Each step in the process may be managed as a state transition in the FSM. Greater details of the implementation of the FSM framework is presented in the diagram of FIG. 6, showing a sequence diagram and the customer 120 or corporate client, the front end 400, the FSM engine 410, the back end 420 and rules engine 430.

The participants in the sequence diagram as part of the KEO network, e.g., the first computing system 110, include the front end 400, which can be any screen or interface that is built to interact with the finite state machine. Another actor is the FSM engine 410, which processes the transitions between states and performs actions to validate the correctness of the data before performing the state transition. The back end 420 is in charge of communication with external components. The rule engine 430 permits the financial conditions and logic to perform actions that are coded in a more suitable way.

The sequence diagram of FIG. 6 shows a simple, exemplary interaction between the main components for the settlement card 105 and interaction among the various different network components. The sequence diagram permits a viewer to visualize how transitions between states occur. Based on an action in a front end interface 400, the FSM engine 410 creates an instance for the machine. A first step may execute pre-actions for the desired machine, which may include common pre-actions such as prepare a database to insert data, check if the status of the machine is valid, verify if the customer was not created before, and similar examples.

Once the pre-actions are performed, the state machine can make the transition for the next step. The transition may fire some actions that are managed by the back end component 420. Some of these actions may send a notification, update a table in the database, or call the rules engine 430 as a separate module to perform any calculation, for example, produce a repayment scheduler as, for example, to determine payment terms between others. If there is not an issue in the tasks, the state machine travels to the next stage.

There now follows a detailed explanation of the stages and actions and the implementation details for the different sub-processes of the FSM such as on-boarding, KYC and underwriting.

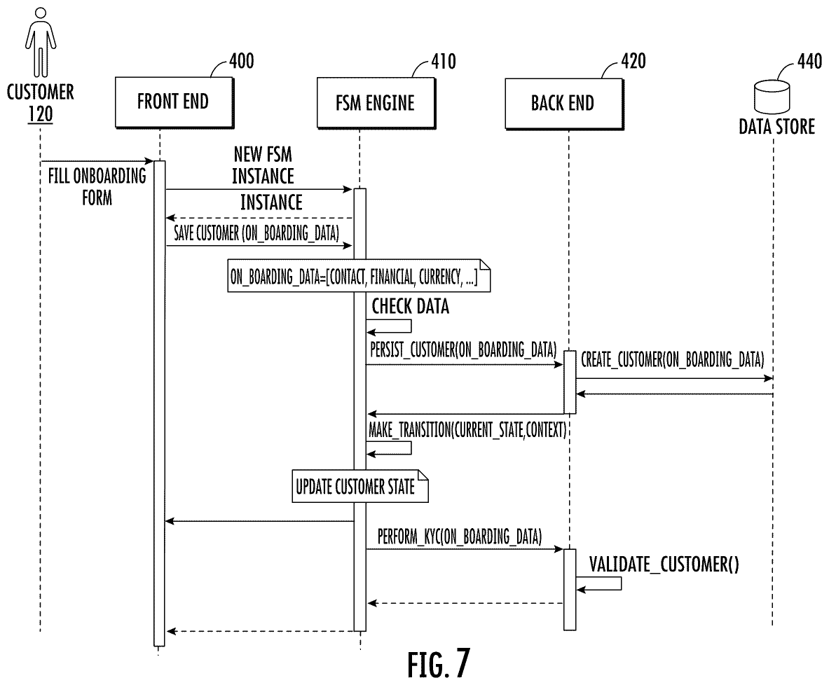

Referring now to FIG. 7, the onboarding process starts by filing a credit form. Components shown in FIG. 6 are similar as in FIG. 7, but with the addition of the data store 440 as a database in the first computing system 110. The customer 120 as a corporate client may upload basic information, their financial information, for example, bank statements, taxes, invoices, and similar items, and credit alternatives such as payment term, currency, and similar factors, which are related to the terms of the settlement card that is offered. The KEO network operating the first computing system 110 also may pull this past financial transaction data and associated business data for each customer and corporate client from public and private data sources and extract customer data features as decision values. Once the user submits this on-boarding form, such as from a wireless terminal or computer, the FSM engine 410 may create a new instance and persist in the database 440 for the KEO network operating the first computing system 110 all the gathered information using the back end component 420 as a wrapper for the related business logic.

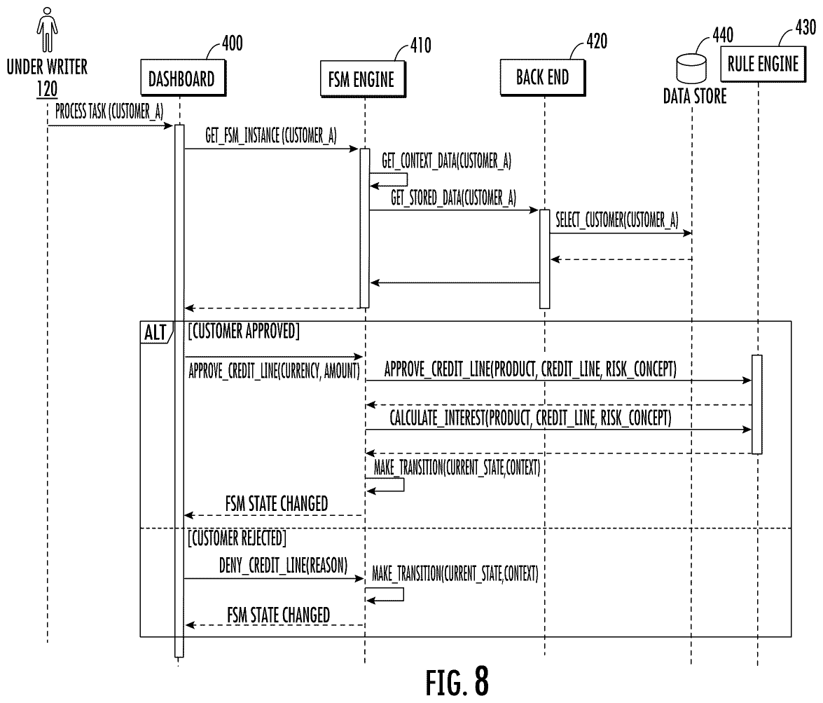

If all the activities were completed successfully, the FSM will make a transition for the next step that is the KYC. The KYC may be implemented by a third party. If the KYC is successful, the next stage is the underwriting, where the credit terms on the first transaction for the customer may be estimated as shown in the sequence diagram of FIG. 8.

Once the user identity is validated in the KYC stage, the credit underwriting is performed at the KEO network operating the first computing system 110. The underwriter module of the KEO network may select an instance in the dashboard, and the FSM engine 410 may load all the related information of the customer 120 as a corporate client, which is input with the supporting facts to evaluate the financial risk and payment capacity estimation. Machine learning and rule-based processing may be employed as explained below.

Based on the expert evaluation, two possible outcomes can occur. The first outcome is when a customer is approved. In this case, the conditions to create the terms of a first transaction for a customer settlement card 105 are sent to the rule engine 430. Based on the scoring, specific credit terms and currency may generate a payment schedule that incorporates a platform fee, interest and due date. The credit terms are returned and the FSM engine 410 may change the state of the machine to a next step where the settlement card 105 is created and sent to the customer 120 as explained previously. If the customer 120 is rejected in the underwriting evaluation, the FSM performs a state change and communicates the decision to the customer.

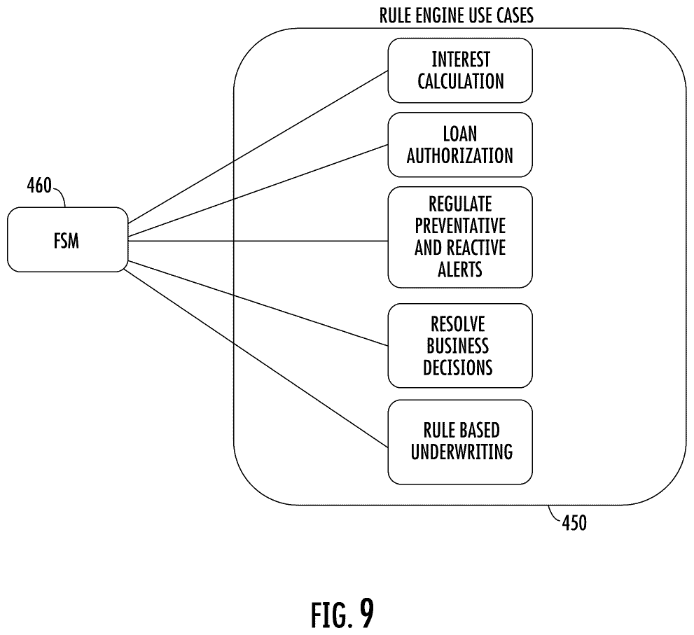

Referring now to FIG. 9, rule engine use cases may incorporate various uses as part of a rule engine module 450, which is a core component operative with the FSM 460. A detailed description now follows.

The rule engine module 450 operates as a system that manages and evaluates business rules that may be derived from the parameterization of legal regulations, company policies, product design and other sources. The rule engine module 450 may be combined with a series of tools to allow the KEO network to take the data from different parts of the company and parameterize, test, execute, and maintain the business rules independently from other modules that make up the software architecture.

The rule engine module 450 centralizes, manages, and maintains the financial logic of the various processes and systems of the KEO network architecture as the first computing system 110. An objective is to parameterize the financial logic so that it defines the decision making of the different processes that take place in the KEO network, allowing it to be highly malleable and independent of the other components that can remain agnostic to this logic. FIG. 9 shows the various rule engine use cases such as interest calculation, loan authorization, regulation of preventative and reactive alerts, regulation of business decisions, and rule-based underwriting.

The rule engine module 450 is adaptable and independent of its functionalities in order to minimize the effort derived from making changes and the impact of its failures on the rest of the KEO network as the first computing system 110. The rule engine module 450 may take a parameterization of the business rules and combine it with a data source to generate a useful result for any systems that integrate with this rule engine module.

In order to parameterize the business rules and reduce the effort to make changes, it is necessary to define a structure that adequately represents the business rules. The storage and administration of this data related to the parameterization occurs with the financial module, allowing it to be independent of the logic executed in other modules.

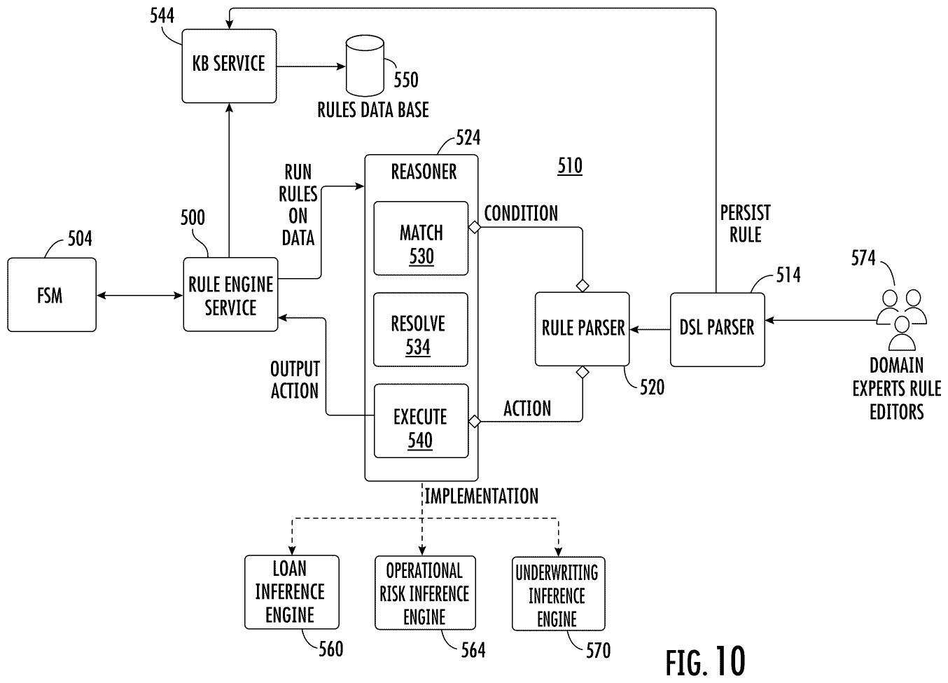

Referring now to FIG. 10, the functional component blocks of the rule engine architecture are illustrated. The rule engine architecture includes several modules that allow it to have a fine grained control over the overall process of creating, editing and evaluating a rule based on the input data. The primary components shown in the diagram of FIG. 10 include a rule engine service 500 operative with the FSM 504. This component may be a rest API or controller to pass the input as JSON and obtain the response from the rule engine shown generally at 510. This component may be the interface between the rule engine and the FSM 504 with the Reasoner 524 and other components, which make use of the coded rules for some of the stages as underwriting or loan payment scheduling. This component also evaluates the input data before passing it to the rule engine. The data should be complete and may follow a defined structure for a related rule.

The DSL (Domain Specific Language) parser 514 may describe the rule's conditions and actions. The DSL may define in general terms conditions and actions. For example, conditions should be satisfied for the rule to execute actions. If there are more conditions in the list, all usually should be satisfied. The actions may occur when all conditions from the list of conditions are satisfied and actions may be executed.

A rule parser 520 may validate the rule defined in the DSL 514 and creates an in-memory AST (Abstract Syntax Tree), which may be used to resolve the rule when data enters the system to be evaluated. The Reasoner 524 may be a core part of the rule engine 514. In this example, the Reasoner 524 operates as an inference engine where the input data is evaluated based on the defined rule conditions using a Rete algorithm as an example for an enhanced performance. The execution of the rule on input data may include three steps.

In a first MATCH module 530, the facts/conditions and data are matched against the set of rules. It returns the set of satisfied rules. In a second RESOLVE module 534, the conflict set of rules are resolved to give the selected one rule. In a third EXECUTE module 540, the action of the selected one rule is run on given data and the resulting output returned.

A KB service 544 may encapsulate the logic to interact with the rules database 550 where the rules that are implemented in the rule engine 510 are stored. In this example, the rules database 550 may be formed as a non-relational database within the first computing system 110, such as mounted on a Firestore database service. This rules database 550 stores collections that group a series of business rules that are parameterized in a structured JSON file. The collections in turn serve as a versioning of the business rules. The Reasoner 524 implements and interoperates with the Loan Interference Engine 560, Operational Risk Interference Engine 564, and Underwriting Interference Engine 570. The DSL Parser 514 interoperates with Domain Expert Rule Editors 574.

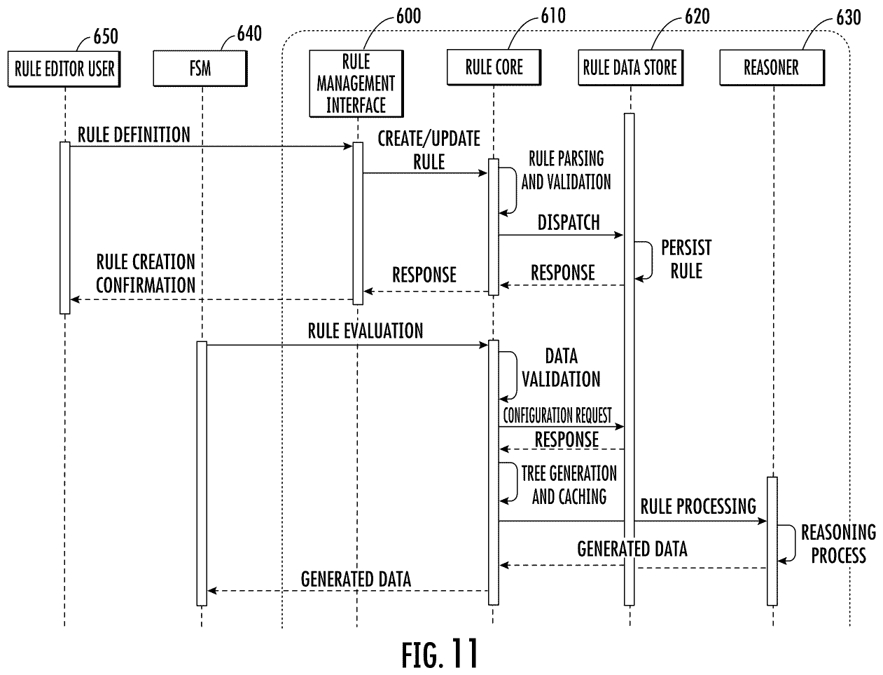

Referring now to FIG. 11, the sequence diagram helps to describe the operation of the rule engine. In the sequence diagram, the actions are chained for the rule creation until rule evaluation. The Rule Engine Module includes Risk Management Interface 600, Rule Core 610, Rule Data Store 620, and Reasoner 630, with the Rule Engine Module operative with the FSM 640 and Rule Editor User 650.

The administrator rule engine module includes an administration or rule management interface 600 to create or maintain the rules. Upon performing an action, the interface 600 sends a request to a handler component, which validates the structure of the new rules and checks their consistency. If there is an error, the system informs the user that the action could not be performed successfully. Otherwise, the new version of the rules is persisted in the rules database and the user is shown the confirmation.

To evaluate the rules, the module validates that the information provided is sufficient to perform the evaluation and then loads the latest version of the rules. These two inputs, the information base and the rules, are passed to the reasoner 630 component, which delivers the inferred information. A cache as part of the first computing system 110 stores the trees created from the configuration to optimize the evaluation of the business rules in the same context.

An advantage of storing business rules as logic outside the source code is the ability to mutate rules almost instantaneously without the requirement for code deployment, thus reducing module downtime. The grouping of rules in contexts brings two advantages. The first advantage is the independence of the contexts. If one of the contexts is not configured correctly, the others can operate normally. The second advantage is the possibility of chaining the evaluation of several rules of the same context while maintaining the individuality of the rules and allowing their fragmentation if they are too extended or acquire more responsibility than desired. Thus, the processing is enhanced and made more efficient.

The point-of-sale terminal as part of the authorized card specific merchant 130 allows a merchant to process payments and may be a cash register, smart phone with plug-in card readers to a countertop terminal that prints receipts, scans bar codes, and permits more capabilities. The settlement card 105 may be virtual as noted before, but also may be formed as a chip card embedded with EMV technology and include contactless payment technology. The KYC process verifies the identity, suitability and risks involved with maintaining a business relationship. A third party may be operable since the KYC process may place a costly burden on the KEO first computing system 110. It may include a customer identification program, customer due diligence, and enhanced due diligence.

The underwriting process may take into consideration credit history, debt-to-income (DTI) ratio, income, debt-to-income ratio, and other aspects. The finite state machine operates as a computation model to simulate sequential logic and represent the control execution flow. It may be based on a hypothetical machine and store the state at a given time. Typically, the machine may be in a fixed set of states and only one state at a time where a sequence of inputs may be sent to the machine. Every state may have transitions and every transition may be associated with an input pointing to a state. It is possible to use a stack-based FSM that stores elements in a LIFO (last-in, first-out) to save the different states. The finite-state machine may be a deterministic finite-state machine and non-deterministic finite-state machine.

As noted before, a REST API may be used as a representational state transfer as a software architectural style. Each REST message may contain information necessary to understand that message and may use an HTTP request, such as defined in RFC 2616 where no protocol conventions may be required for client and server communications. The HTTP request may include different requests such as GET, POST, PUT, and DELETE as HTTP request methods. It may include statelessness where client and server communications contain the information needed to execute the request, caching, a uniform interface, a layered system and code-on-demand. It may be useful with the JSON (Java Script Object Notation) to exchange data between web clients and web servers as an alternative to XML.

As noted before, a non-relational database as part of the first computing system 110, such as a non-SQL database, provides for storage and retrieval of data other than in a tabular relation used in relational databases. The rules engine 510 (FIG. 10) as described may also include a reasoner inference engine that optimizes each set of new rules and applies a forward chaining model to the decision values based upon new inferences and applies an expert system as a backward chaining model to decision values. It may establish a syntax tree for each set of new rules, such as for each new transaction for the settlement card. It may infer logical consequences from asserted facts or axioms. A forward chaining technique of the inference or reasoner inference engine may start with the available data such as financial transactions and behavior variables as part of business data, which may be related to business transactions of a respective customer, the social characteristics of the respective corporate client when interacting with the public, and the business relationships of the respective customer with different companies. Inference rules may be used to extract more data until a goal is reached.

For example, forward chaining may be used to search the inference rules until it finds one where an antecedent if clause is known to be true and can include a consequent then clause resulting in the addition of new information to its data. At the same processing, the settlement card system 100 via the KEO first computing system 110 may use backward chaining or reasoning and may employ a depth-first search strategy and start with a list of goals or a hypothesis and work backwards from the consequence to the antecedent to see if data supports any of the consequents. The inference engine may use backward chaining to search the inference rules until it finds one with a consequent then clause to match a desired goal.

The syntax tree may be a representation of those syntactic structure effects and be different from a parsing tree that is built by a parser during source code translation and compiling. The AST can be edited and enhanced with properties and annotations for every element it contains, such as the past financial transaction data and associated business data and the acquired decision values.

The first computing system 110 as the KEO network may also use the Rete algorithm to implement rule-based systems using a pattern matching algorithm. This is an advantage over those expert systems that may check each rule against known facts in a knowledge base and discard that rule, if necessary, and move onto the next rule and loop back to the first rule when finished. This is a slow approach and the Rete-based expert system builds a network of nodes where each node except the root corresponds to a pattern occurring in the conditioned part of a rule. As new facts are asserted or modified, such as related to associated business data and past financial transaction data and the data features as decision values, the facts propagate along the network, causing nodes to be annotated when that fact matches a pattern.

Thus, each time a transaction is made by the settlement card 105, further financial transaction data and associated business data may be collected for each customer 120 from public and private data sources and the KEO network, first computing system 110 extracts customer data features as decision values. The rules engine may apply to machine learning approval model as a set of rules to the decision values and determine a settlement card monetary limit and payment terms for a specific, single transaction with the card specific merchant 130 to which the settlement card 105 is authorized for use. The Rete algorithm is especially applicable with the forward chaining and “inferencing” to calculate new facts from existing facts and filter or discard facts related to the past financial transaction data and associated business data to arrive at a conclusion.

The customer 120 as a corporate client may have data features that may include behavior variables having information related to websites visited by the customer, product categories purchased by the customer, stores visited by the customer, ratings on e-commerce websites, and the consumer segment to which the customer belongs. The identity characteristics of the customer data features may include information related to home addresses of executives and workers, neighborhood profiles of these executives and workers, length of present residence, education level, employment history, and educational level of the executives and current and/or past workers. The social relationships of the data features may include information relating to social media and photo attributes that include features inferred from image processing of public photographs found of the customer and social networks and search engines. The behavior variables, identity characteristics, and social relationships may include other data as indicated relative to the systems as described.

Different attributes may be collected from public data sources corresponding to customer and corporate client features. They may be transformed into data as a user attribute string and stored with other user attribute strings and pre-approved loan amounts in the database system, such as in Parquet format. The settlement card system 100 may use SQL statements with a database system to query attributes and acquire the relation between them with intuitive, fast processing. The different processors and servers and cloud-based processing functions of the first computing system 110 may interoperate with relational attribute databases and NoSQL (non-relational) transactional database system and generate user ID's associated with user attribute strings. Additional attributes may be linked to transactions made by the customer 120 as the corporate client over time and especially the last 24 hours may be made and linked to a user attribute string that is stored long-term in a transactional database such as the database system. The added transactional data may have many different attributes associated with new transactions from the customer that occurred over the last 24 hours, days, or weeks, including the user, date, type of transaction, location, and numerous other details. Trying to load this data into a relational attribute database may create an immense burden when the system later is required to obtain information using a relational database engine for applying any machine learning models.

A transactional database system may incorporate a WS Dynamo database that interoperates with different processors as part of its system and delivers millisecond performance at any scale to allow the settlement card system to write/read huge amounts of non-structured transaction data obtained over days and weeks in an efficient manner and apply it later with the machine learning models. The settlement card system 100 and its KEO first computing system 110 may extract data from many different external public data sources and transform the data and load it into a relational transaction database, for example, as an ETL process.

As an operational example, the data may enter the first computing system 110 from flat text files and internal or external databases. Different AWS tools may be used to create automatic processes for extracting, transforming, and loading the information. When the source of data is an external database, the data may be consulted through an API. Data may be stored in the database system in different formats, for example, in XML format. Automatic identification of data may be processed through crawlers as tools from AWS to identify the data scheme and types without expanding a large amount of time and may be accomplished automatically. After gathering and identifying a data scheme, the settlement card system 100 and particularly the KEO first computing system 110 may clean/transform data, e.g., using a glue program and create a task for data cleaning and transformation, such as changing data format and converting numerical data via a job process. Provisioning and data management may be reduced with scaling of resources required to run an ETL job, which may be managed on a scaled-out apache spark environment. Data may be stored in Parquet format in relational attribute databases, including S3 buckets.

It is possible for the settlement card system 100 and particularly the KEO first computing system 110 to communicate an authentication request and verify corporate client identity and bank account data from a financial institution, and select and extract client data features from public data sources, including: 1) behavior variables related to business transactions, 2) social characteristics, and 3) business relationships. It is possible to generate private access tokens and use computing endpoints to obtain corporate client transaction data. Different computing endpoints may track transactions of a corporate client over time, such as over 24 hour periods, and extract and update client data features and client transaction data, which can be processed and transformed into new and updated client data features and client transaction data.

It is possible to use Open Location Code (OLC) as part of a geocode system and generate a Plus code, which is a technique of encoding a location into a ten-digit data string, which is a form that is easier to use than coordinates in the usual form of latitude and longitude. Some of the public data obtained with the settlement card system 100 may be geographically relevant, and for every point on Earth, there may exist a Plus code associated with it that may have a prediction up to area of about 14×14 meters. There may be some pre-calculation of public variables, and they may be assigned to corresponding Plus codes. The settlement card system 100 may be able to relate this to a customer's corporate information. For example, when the settlement card system 100 obtains the corporate data, including one or more addresses, the KEO first computing system 110 may transform the address into coordinates and the network obtains the Plus code for that coordinate, such as when a settlement card is used.

Because it may be difficult to make a single and normal query to obtain all the public variables assigned to a given Plus code, the query may be a string comparison. Some data may be obtained in JSON format. Computing endpoints may impart computational efficiency because specific data is extracted to be a specific computing endpoint. For example, for transactions over time, only new transactions may be required and the computing endpoints may be separated to avoid overload of any machine learning process by ingesting only required data and improving calculation time. For example, an authorization computing endpoint may obtain a corporate client's bank information and ACH data such as in account number, routing number, and other data. A transaction computing endpoint may obtain the past transactions such as 30 days or last 24 hours from a corporate client. A balance computing endpoint may obtain available balances from the bank account or multiple bank accounts. An identity computing endpoint may retrieve corporate information stored at a banking institution hosting a corporate client banking account. It is possible to use POST and JSON programming functions. Web hooks may be applied.

Any database network that is part of the first computing system 110 or other systems may include a powerful indexation system in association with a cluster, which retrieves large amounts of data using fewer queries. It may input massive amounts of data quickly even when the transactional data from the bank or other financial institution to which the customer belongs could have a very different composition. As the machine learning model functions, the settlement card system 100 and particularly the KEO first computing system 110 may scale on-demand if it is required. A database network may operate in a cloud or serverless environment and interoperate with the cache system as an in-memory data storage and may be operable to retrieve all required data with a low latency.

The settlement card system 100 may operate also as an API with a cluster and other processing systems associated with any of the first, second and third computing systems 110, 140, 150. As illustrated and described before, the transactional data from a financial institution related to a customer may be pulled as banking data through an event driven, computing platform, which may be part of the cloud and processor functions and into transaction and NoSQL databases. Corporate client transactions may be saved together with publicly available data that may have been used to issue the settlement card 105. Data may be obtained and imported via a cluster. Decision values may be updated every 24 hours and stored again in a database network and the last 24 hour transactions, decision values, and any predictors cached in the cache system.

A database network may allow storage and retrieval of data that is modeled in a manner other than the tabular relations used in relational databases and provides simplicity of design without the “impedance mismatch” between the object-oriented approach to write applications and the schema-based tables and rows of a relational database. It is possible that customer data such as used for the transactions, any latest predictions, and any decision values may be stored in one document as opposed to having to join many tables together. There may be better horizontal scaling to clusters of machines and final control over the data availability.

Key-value pairs may be used to store several related items in one “row” of data in the same table. For example, a non-relational table for the same bank or financial institution may have each row, including corporate client details and account, loan and other information obtained and used by the settlement card system 100. All data relating to that one customer 120 having the settlement card 105 issued to them may be conveniently stored together as one record. Data may be distributed across many different servers. Serialized arrays may be stored in JSON objects and records may be stored in the same collection having different fields or attributes.

It is possible that the database network may include an object database and store the data and objects to replicate or modify existing objects to make new objects, such as data relating to the decision values, and if accomplished, corporate client predictions. Different serverless databases may be used, and in an example, a Dynamo database (DynamoDB) may operate as a managed NoSQL database service as part of the database network. It may be straightforward to store and retrieve different amounts of data and serve many levels of requested traffic. The settlement card system 100 and associated API and database network may support key-value and document data structures, and a database network service may rely on the throughput rather than storage. A table may feature items that have attributes that form a primary key in an example as related to the customer transactions in a customer transactions database and decision values such as publicly available information as stored in a decision values database.

The settlement card system 100 may issue queries directly to indices, such as a global secondary index feature as a partition key and the local secondary index feature. Hashing may be used to manage data and the data distributed into different partitions by hashing on the partition key. The database network structure may have no service to provision, patch or manage. The settlement card system 100 and particularly the KEO first computing system 110 may scale tables up and down to adjust for capacity and maintain performance.

The settlement card system 100 may use an accelerator and in-memory cache system as part of the first computing system 110, such as an in-memory data store and cache system where the cache is placed between the application and its database tier. On-demand cache nodes or reserved cache notes may be used for on-demand nodes and provide cash capacity by the hour or reserve nodes with a more extended commitment. An example is an elastic cache.

The cache system at the first computing system 110 may store any last predictions, such as 24-hour time periods and customer features for a specific settlement card 105 owned by a customer, the last 24-hour transactions of that specific settlement card for the customer and pulled from a customer transactions database and include publicly available information. The last 24-hour transactions may be obtained and pulled from the customer transactions database. A processing cluster may pull data from the customer transactions database and publicly available information and calculate decision values every 24 hours, and store the decision values in the database as non-limiting examples. Initial data sources may include a bank's transactional data that is pulled as transactional banking data by the first computing system 110 as the settlement card system 100 and by a Lambda service that runs in response to events and automatically manages the computing resources. The settlement card system 100 may permit image and object uploads and updates to the customer transactions database by responding to inputs and provision back end services and custom http requests.

As noted before, the process of approving a transaction may include basic steps as defined generally by the settlement card system 100, where the system obtains the customer data from a bank using an off-line process and processes those transactions in order to calculate decision values to be used in the settlement card limit. The final step may be gathering the transaction data and in conjunction with the pre-calculated values, and running the machine learning model. Sometimes very large card processors cannot afford to introduce another call to an external service due to several factors: time, policies, security, and similar factors. To tackle this major issue, a last step may be sent to a processor decision engine. For example, a processor at the first computing system 110 may be given a predictive model transformed into linear formulas, and implemented using the same programming language as a loan credit engine. There may still be a pre-calculation of decision values, but these values may be previously transferred to the engine using SFTP or an API. It does not have to be in real time.

As a result, there are similarities, but the machine learning model may include a scheme where there is no need for deploying global real-time API. Instead, pre-calculated values may be provided and the same data may be used. The first computing system 110 may make a decision by using the model. The pros about this solution are that the decision processing would be faster because no need to make an external API call, and thus, there would be fewer calls, and thus, fewer issues.

The machine learning model may be operative as a loan rule engine and may use machine learning data behavior analysis and predictive mathematical models. A credit scoring algorithm as part of the loan rule engine may adjust scoring continuously based on data correlation in order to optimize the value of the maximum loan issuance on the settlement card 105 and the maximum number of loans that are issued to a customer, for example, as a factor of a minimum bad debt value. These decisions can be applied to settlement card issuance.

A credit score may be based on the average credit among a plurality of customer profiles stored within a transaction database, and by matching a data attribute string based on the user ID number and the initial set of data to determine a maximum allowed credit for the corporate client. An initial loan may be approved based on the maximum allowed credit of the corporate client. A behavioral profile for the customer may be generated based on the location and check-ins.

A behavioral profile for a customer may be generated using a customer conversation modeling or a multi-threaded analysis or any combination thereof. The behavioral profile may be based on segmentation with corporate client information provided via the contents of each transaction and using affinity and purchase path analysis to identify products that sell in conjunction with each other depending on promotional and seasonal basis and linking between purchases over time.

The settlement card system 100 may determine when the customer requires an increase in the maximum allowed credit for each new transaction and the risk involved with increasing the maximum allowed credit. A due date for repayment of the amount may be established and the settlement card system 100 may store data about repeated transactions with the customer that includes repayment data for each transaction. Based on that stored corporate client data, the settlement card system 100 may apply a machine learning model to the loan data.

A regression model may have a moving window that takes into account mean, standard deviation, median, kurtosis and skewness, past input/output data may be input to the machine learning model. This past input/output data may include a vector for the input relating the past consumer loan data and an output relating to a probability between 0 and 1 that indicates whether a customer can repay. In yet another example, a probability greater than 0.6 may be indicative of a high risk that the customer will not pay. The target variable outcome from the machine learning model may comprise a binary outcome.

The method may further include generating behavioral profile based on segmentation with a customer information provided via the contents of each transaction and using affinity and purchase path analysis to identify products that sell in conjunction with each other depending on promotional and seasonal basis and linking between purchases over time.

The Amazon Web Services (AWS) is described in a non-limiting example may be integrated with the settlement card system 100 with the API operating with a CloudFront, but other types of network systems could be implemented and used besides the AWS. The customer using the settlement card 105 for the loan may operate a mobile device and its application with an interface to the Amazon Web Services Web Application Firewall (AWS WAF) to protect web applications from common web exploits and provide security as shown by a secure lock logo, which includes appropriate code and/or hardware components to protect against compromising security breaches and other occurrences or data breaches that consume excessive resources. The settlement card system 100 may control which data traffic to allow, may block web applications, and may define customizable web security rules. Custom rules for different time frames and applications may be created. The operator of the settlement card system 100 may use an API such as associated with the settlement card system.

The AWS WAF in an example may be integrated with an Amazon CloudFront, which typically includes an application load balancer (ALB). The CloudFront operates as a web service to permit effective distribution of data with low latency and high data transfer speeds. Other types of web service systems may be used. The Amazon CloudFront interoperates with a Virtual Private Cloud (VPC) and provisions logically isolated sections of the CloudFront in order to launch various resources in a virtual network that the settlement card system defines. This allows control over the virtual networking environment, including IP address ranges, subnets and configurations for route tables and network gateways. A hardware VPN connection could exist between a corporate data center as operated by the KEO first computing system 110 and a Virtual Private Cloud and leverage the AWS CloudFront as an extension of a data center. The data center of the first computing system 110 may include appropriate servers or processors, databases, and communications modules that communicate with a server corresponding to the KEO first computing system and the other second and/or third computing systems 140, 150, which in a non-limiting example, could incorporate a corporate data center.

As part of a Virtual Private Cloud is a Representational State Transfer (REST) Application Programming Interface (API) that provides interoperability among computer systems on the internet and permits different data requesting systems to access and manipulate representations of web resources using a uniform and predefined set of stateless operations. The Amazon Web Services may interoperate with an AWS Key Management Service (KMS) and manage encryption and provide key storage, management and auditing to encrypt data across the AWS services. An AWS CloudTrail records API calls made on an account and delivers log files, for example, to an “S3” bucket or database as a cloud storage in one example with one or more databases such as could be part of a data warehouse operative as the transaction database and provides visibility of the user activity since it records the API calls made on the account of the system. The CloudTrail may record information about each API call, including the name of the API, the identity of a caller, the time and different parameters that may be requested or response elements returned by the service in order to track changes made to AWS resources and determine greater security and identity of the card customer, such as when initially requesting a settlement card 105.

An AWS Identity and Access Management (IAM) may permit the settlement card system 100 to control individual and group access in a secure manner and create and manage user identities and grant permissions for those users to access the different resources. The AWS Cloud HSM service may permit compliance with different requirements, including data security using a hardware security module appliance within the cloud. It may help manage cryptographic keys. The AWS CONFIG module permits compliance auditing, security analysis, change management, and operational troubleshooting. The different resources may be inventoried with changes in configurations and reviewed relationships. The REST API may interoperate with the Loan Rule Engine as part of a controller and Data Warehouse.

A data warehouse may receive data from data sources that interoperate with ETL (extract, transform, load) jobs and machine learning components that in turn interoperate with a data store such as the Amazon simple cloud storage service (S3), and in a non-limiting example, Amazon Redshift as an internet data warehouse service. These components via machine learning interoperate with a business intelligence reporting module. In this process, it is possible to analyze data using a SQL (Structural Query Language) and existing business intelligent tools to create tables and columns with the most accurate data types and detect schema changes and keep the tables up-to-date. Many dozens of data inputs can be connected and mash ups may be created to analyze transactional and corporate client data. It is possible to use both relational and non-relational databases depending on the types of data.

An example of the initial data structure generated for each customer is: user ID; Attribute 1; Attribute 2; Attribute 3; Attribute 4; . . . ; Attribute N. The settlement card system 100 and particularly the KEO first computing system 110 may use this initial attribute string to generate a credit score for this customer by matching this user attribute string to the database and applying the maximum credit score for the customer profile that in an example may be calculated as an average credit among different customer profiles matching the initial set of attributes. Hereinafter, customer will also be referred to as corporate client as use of the settlement card.

Initial corporate client ID: N attributes
a) Corporate clients Database Match:
Filter by corporate clients that match the same N attributes values: X user profile with N+Y to Z attributes;
b) Maximum Credit Calculation:
Average value of Maximum Credit for corporate client profiles with N+Y to Z attributes;
Correlation and probability of repay loan prediction for corporate client profiles with N+Y to Z attributes; and
Apply business rules.

Once the new corporate client is recorded in the Data Warehouse and the initial Maximum Credit score generated, the settlement card system 100 and particularly the KEO first computing system 110 may initiate the process of adding and computing new attributes to the corporate client profile using the loan activities and acquiring all transactional data. In this example, the corporate client transactional data may be imported from a transactional application API once every X hours.

The settlement card system 100 may also match relevant external attributes to a corporate client profile. The settlement card system 100 may generate a database of external data that are imported from a variety of public domain sources as the external data sources in an example. This external data may be continuously updated and correlated to corporate clients and linking to initial generic attributes, e.g., location linked attributes; purchase linked attributes over time; and other business related attributes of the corporate client.

The new data attributes may be stored in a data warehouse and associated to the unique user ID as a user ID and attributes as N (initial)+X (transactional)+Y (external)+Z (loan/repayments). These activities include loan transactions (loan taken, use of loan, amount, date and time) and repayment activities (repayments, amount, date and time) based on the settlement card 105 usage.

Digital behavior may be taken into account, such as cash-in transactions related to the settlement card 105 usage (amounts, type of cash-in, location of cash-in, date and time); cash-out transactions (amounts, type of cash-out, location of cash-out, date and time); bill payment transactions related to the corporate client's other transactions (type of bill, status of bill [expired, early payment, on-time], amounts, date and time); purchase transactions (amounts, type of purchase, location of purchase, date and time); log-in activities (log-in date and time, duration of session, session flow, time spent on each screen); sales transactions (sales value, type of product sold, location of sale, date and time); commission transactions (commission value, type of commission, date and time); the money transfer transactions (sent/received, sent by/received by, value, location, date and time); and any other transactional or activity that may be determined as related to the corporate client.

Any external and public data may be received from the external data sources and include data collected from public domain sources, paid for data sources, and historical data archives of the corporate clients and be taken into consideration for each new transaction of the settlement card 105 and to apply new business rules.

External variables may be used to determine the creditworthiness and risk of a corporate client as a potential customer and the decision variables. The same data may be used to assist in the determination of the monetary value of the settlement card 105 and ultimate payment terms for each transaction. External variables may be considered as all public information and may be collected through geo-location information such as public and private infrastructure, any ratings of the corporate client, and public evaluations. Common data sources include web mapping services such as Google Maps and Open Street Maps, web services, web pages, and public data repositories. The various data sources as non-limiting examples may include Open Street Map, Google, Trip Advisor, and other sources.

For example, the Open Street Map application may be available via the Amazon web services cloud storage (S3) and the Google Places API and Web Services may interoperate with Google, including Google Maps and a Geocoding API. Web scraping may be used together with other acquisition methods to obtain further information on corporate clients. There are many other possible data acquisition methods to be taken advantage of. Data may be gathered and copied from the web to a local repository and raw data is then cleansed, transformed, aggregate features constructed, and final features selected. It should be understood that the harvest process may be determined by the data source types and some sources could be available for direct download as tables. Other sources may require additional methods to access data. For example, Google Maps data and information may be obtained by querying and request data available on various Google application programming interfaces. The web scraping techniques are a useful tool for accessing information contained in documents such as web pages. A data parser program could be used to parse and capture relevant information. Once raw data is gathered and copied from a source to the local repository, the KEO first computing system 110 may perform a pre-processing stage where data may be cleaned and transformed in order to construct and select new features that may be used for machine learning models.

Different processing methods and algorithms as non-limiting learning methods may be used. For example, a correlation coefficient may be used to infer an association between external variables and a target. Variables at the highest correlation may be considered as better target descriptors. For example, a rank correlation could study the relationships between rankings of different variables or different rankings of the same variable while the measure of the strength and direction of a linear relationship between two variables may be defined as a (sample) covariance of the variables divided by the product of their (sample) standard deviations.

An information gain method may be used where the settlement card system 100 calculates the relevance of the attributes based on information gain and assigns weights to them accordingly. The higher the weight of an attribute, the more relevant it is considered. Although information gain is usually a good measure for deciding the relevance of an attribute, it may have some drawbacks and a problem may occur when information gain is applied to attributes that can take on a large number of distinct values. This issue may be tackled with a gain ratio. In any decision tree learning, the information gain ratio is a ratio of information gain to intrinsic information and may reduce a bias towards multi-valued attributes by taking the number and size of branches into account when choosing an attribute. A random forest with gain ratio methodology trains random forest with gain ratio as an attribute selector. Information may be considered as a gain ratio for generating attribute weights. This decision methodology is also known as random decision forest and operates in one example by constructing a multitude of decision trees at training time and outputting the class that is the mode of the classes as classification or mean prediction as a regression of the individual trees.

It is also possible to use a weight by Gini index that calculates the relevance of the attributes of the given external variables set based on the Gini impurity index. The weight by Gini index operator calculates the weight of attributes with respect to the target attribute by computing the Gini index of the class distribution. The higher the weight of an attribute, the more relevant it is considered. This operates as a measure of statistical dispersion in the Gini coefficient making equality among values of a frequency distribution.

It is possible to use a weight by Support Vector Machine (SVM) that computes the relevance of the external variables by computing for each variable of the input set the weight with respect to the target. This weight represents the coefficients of a hyper plain calculated by the SVM. They operate as a supervised learning model that analyzes data used for classification and regression analysis.

It is possible to use different types of prediction models and algorithms as machine learning methods and business rule adaptations that help generate profiles to predict a corporate client profile and periodicity of credit patterns using the settlement card, including loan amounts, loan repayments, and past and present transaction activities and use with the settlement card system 100 for each singular transaction. For example, it is possible to use Customer Conversation Modeling (CCM) that takes advantage of the behavior data such as the buying trends, purchasing history, and including even corporate social media activity that may be available publicly. It is possible to use a multi-threaded analysis of the patterns such as corporate client churn, risk or acquisition prediction based upon the settlement card usage and other business activities, and traditional tools that may include batch calculation of linear regression or classification models.

A customer conversation modeling may enable the KEO first computing system 110 to predict corporate client behavior before it happens, and thus, change rules applied by the rule engine for each transaction and focus on multi-threaded behavior such as trend detection for setting changes in behavior that are more important than sustained behavior patterns, and recognize cyclical patterns that take into account the time and location, and the depth/breath of the historical interaction with the corporate client in a multi-threaded pattern. Alignment algorithms may track events across channels and align them in time and find correlation between multi-channel behavior.

It is possible to use fuzzy clustering, principal component analysis and discriminative analysis. Some techniques may include sequential pattern mining and association rule mining. It is also possible to use a weight factor and utility for effectual mining of significant association rules and even make use of a traditional Apriori algorithm to generate a set of association rules from a database and exploit the anti-monotone property of the Apriori algorithm. For a K-item set to be frequent, all (K-1) subsets of the item set may have to be frequent and a set of association rules may be mined and subjected to weight age (W-gain) and utility (U-gain) constraints. For every association rule that is mined, a combined utility weight score may be computed.

It is possible to use the decision trees and other data mining techniques. Decision trees regarding rule changes per transaction and different monetary amounts that can be changed with the settlement card 105 change with each transaction, as well as the payment terms. The decision trees may split a large set of data into smaller classes and analyze where each level of the tree corresponds to a decision. The nodes and leaves may include a class of data that are similar to target variables. There could be nominal (categorical and non-ordered), ordinal (categorical and ordered), and interval values (ordered values that can be averaged). The decision tree may have every leaf as a pure set and a tree may be split further until only pure sets are left as long as subsets do not become too small and give inaccurate results because of idiosyncrasies. One possible algorithm may be the ID3 or Iterative Dichotomiser 3 as a decision tree constructing algorithm that uses Entropy as a measure of how certain one can be that an element of a set is a certain type.

It is also possible to use different analytical techniques such as A/B/multivariate testing, visitor engagement and behavior targeting. Different advanced analytics may be applied such as corporate client segmentation that groups corporate clients statistically together based on similar characteristics to help identify smaller and yet similar groups for targeted marketing opportunities and to help adapt rule changes and maximize the settlement card amounts with the best payment terms. Basket segmentation may allow corporate client information to be provided through the contents of each transaction, while affinity and purchase path analysis may identify products that sell in conjunction with each other depending on promotional or seasonal basis and links between purchases over time based upon each new transaction. A marketing mix modeling may provide some response models from promotion campaigns and product propensity models and attrition models that predict behavior.

Other models such as logistic regression, neural networks or random forest may use vector-based models that operate on feature vectors of fixed length as an input in which each there are no assumptions of intrinsic temporal nor spatial relationships between the values on different positions inside the vector. The corporate client purchase, marketing activities, and financial histories of different transactions may be converted into a fixed set of features that may be crafted by domain experts and artificial intelligence nodes and reflect indicators with a reliable set of features for prediction accuracy. Different iterations of empirical experiments may be used.

One possible technique may use recurrent neural networks (RNNs) to overcome vector-based methods that can be applied to a series of captured corporate client actions and data that maintain a latent state that is updated with each action. One drawback of the vector-based machine learning similar to logistic regression is the requirement for domain knowledge and data science intuition and may include a necessary pre-processing that creates binary input vectors from original input data. Signals that are encoded in the feature vector are picked up by a model where the purpose is to detect patterns that would relate the input feature vector to the value to be predicted.

In contrast to vector-based methods, recurrent neural networks (RNNs) take sequences X=(x₁, . . . , x_{T}) of varying length T directly as inputs. RNNs may be built as connected sequences of computational cells. The cell at step t takes input x_{T} and maintains a hidden state hₜ€R^{d}. This hidden state is computed from the input x_{T} and the cell state at the previous time-step hₜ₋₁ as:

hₜ=σ(Wₓxₜ+Wₕhₜ₋₁+b),

where Wₓ and Wₕ are learned weight matrices, b is a learned bias vector and σ is the sigmoid function. It is possible to use a hidden state hₜ that captures data regarding the corporate client from the input sequence (x₁, . . . , x_{T}) up to a current time-step t. It is possible to prepare over time the data from early inputs. The dimensionality d of the hidden state may be a hyperparameter that is chosen according to the complexity of the temporal dynamics of the scenario. These types of deep neural networks have the capacity to consider temporal relationships between the inputs, which may be important if there is a pattern relating to historical sequence of transactions of each corporate client with the variable they want to predict, such as whether the corporate client is going to pay or not.

It is possible to use long short-term memory cells (LSTMs) or gated recurrent units (GRUs) that help preserve long-term dependencies and help maintain an additional cell state C for long-term memory. Those types of networks preserve relationships that would be lost after some steps in the data sequences if it used regular RNNs by using not only a hidden state relating each step with the previous step, but a cell state, relating all previous steps with the next one. It would be possible to calculate any hidden and cell states ht and Ct using a cascade of gating operations:

ft=σ(Wf[ht−1,xt]+bf)

it=σ(Wi[ht−1,xt]+bi)

C\hat{ }t=tanh(Wc[ht−1,xt]+bC)

Ct=ft Ct−1+it C\hat{ }t

ot=σ(Wo[ht−1,xt]+bo)

ht=ot tanh(Ct)

In this cascade, W and b may be learned weight matrices and bias vectors. The final hidden state hT may classify a sequence because hT may be input into a prediction network, which can be a simple linear layer or a sequence of non-linear layers.

There may be a training period for machine learning models applied with the rule engine and the parameters W and b of the computational cells may be used to detect signals in the input sequences in order to help increase the prediction accuracy. Input sequences X may be compressed by this process into suitable feature vectors hT. The compression process may be viewed as feature learning from raw inputs.

The machine learning and rules as applied by the rule engine may take into consideration as moving window points that include measurements such as the mean, standard deviation, and median in which these are a measure of the central tendency of a value of a data set with the mean (average) as the sum of all data entries divided by the number of entries, and the median as the value that lies in the middle of the data when the data set is ordered. When the data set has an odd number of entries, the median may be the middle data entry, and if the data has an even number of entries, then the median may be obtained by adding the two numbers in the middle and dividing the result by two (2). There may be some outliers that are not the greatest and least values, but different from the pattern established by the rest of the data and affect the mean, and thus, the median can accommodate as a measure of the central tendency. There are measures of the variation that the standard deviation takes into effect to measure the variability and consistency of the sample or population. The variance and standard deviation will give an idea of how far the data is spread apart. When the data lies close to the mean, then the standard deviation is small, but when the data is spread out over a large range of values, the standard deviation “S” is large and the outliers increase the standard deviation.

By measuring the skewness and kurtosis and using those variables, it is possible to characterize the location and variability of the data set with skewness as a measure of symmetry or the lack of symmetry such that asymmetric data set is the same to the left and right of the center point. Kurtosis measures whether the data are heavy-tailed or light-tailed relative to a normal distribution. Thus, those data sets with high kurtosis tend to have heavy tails or outliers and those data sets with low kurtosis tend to have light tails or lack of outliers. One formula that may be used for skewness may be the Fisher-Pearson coefficient of skewness. It should be understood that the skewness for a normal distribution may be zero (0) and any symmetric data should have a skewness near zero (0). The negative values for skewness indicate data that are skewed left and positive values for skewness indicate data that are skewed right. Thus, skewed left the left tail is long relative to the right tail.

A logistic regression model or other type of classification model may analyze a dependent dichotomous variable (binary) that may use a regression analysis to conduct when a dependent variable is dichotomous (binary). In an example, it is a predictive analysis and describes data and explains the relationship between one dependent binary variable and one or more nominal, ordinal, interval, or ratio-level independent variables. Also, the regression models may be defined such that the dependent variable is categorical and the algorithm may use the binary dependent variable where the output can take two values “0” and “1” that represent the outcomes. Thus, it is possible to indicate that the presence of a risk factor increases the odds of a given outcome, such as maintaining the payment terms for each transaction by a specific factor as a direct probability model.

With supervised machine learning, the KEO first computing system 110 may operate with machine learning as a function that maps an input to an output based on example input-output pairs and may infer a function from a labeled training data as a set of training examples. Each example may be a pair as an input object such as a vector and a desired output value as a supervisory signal. The training data may be analyzed and an inferred function produced, which can be used for mapping new examples. Generally, the training examples may be determined and the type of data to be used as a training set may be determined and the training set gathered. The input feature representation of a learned function may be determined and the structure of the learned function and corresponding learning algorithm.

It should be understood that a recursive feature elimination (RFE) may repeatedly construct a machine learning model, for example, a regression model or SVM and choose either the best or worst performing feature such as based on coefficients and setting the feature aside and repeating the process with the rest of the features. This can be applied until all features in the data set are exhausted and features may be ranked according to when they were eliminated. With a linear correlation, each feature may be evaluated independently.

As to the moving window also known as a rolling window in a time series, it is possible to assess the model stability over time. Thus, it is possible to compute parameter estimates over a rolling window of a fixed size through a sample. The rolling estimates may capture the instability. It is possible to use back testing where historical data is initially split into an estimation sample and a prediction sample and the model fit using the estimation sample and H-step ahead predictions made for the prediction sample. Thus, a rolling regression with the rolling time window may have the KEO first computing system 110 conduct regressions over and over with sub-examples of the original full sample. It is possible then to receive a time series of regression coefficients that can be analyzed.

It is possible to use a multiple correspondence analysis feature correlation. In this data analysis technique for nominal categorical data, the underlying structures in a data set for financial transaction data, associated business data, and extracted data features for a corporate client as decision values may be detected and represented where the data as points are represented in the low-dimensional Euclidian space. This is an analytical challenge in multi variate data analysis and predictive modeling to include identifying redundant and irrelevant variables and to address the redundancy the groups of variables that may be identified that are correlated as possible among themselves as uncorrelated as possible with other variable groups in the same data set. The multiple correspondence analysis uses the multi variate data analysis and data mining for finding and constructing a low-dimensional visual representation of variable associations among groups of categorical variables. The MCA feature correlation and data can be extrapolated for insights and determine how close input variables are to the target variable and to each other.

The KEO first computing system 110 may validate the variable space correlations such as using a Pearson correlation or a Spearman correlation. Correlation may allow the settlement card system 100 to determine a broad class of statistical relationships involving transactional data of the corporate client and other dependents and determine how close variables are to having a linear relationship with each other. The correlations may indicate a predictive relationship. The more familiar measurement of dependents between two quantities is the Pearson product-moment correlation coefficient where the covariance of the two variables may be divided by the product of their standard deviations. A Spearman rank correlation coefficient may be a rank correlation coefficient and may measure the extent to which, as one variable increases, the other variable tends to increase, without requiring that increase to be represented by a linear relationship. Thus, the correlation coefficient may measure the extent to which two variables tend to change together and describe both the strength and direction of that relationship.

A Pearson product moment correlation may evaluate the linear relationship between two continuous variables and it is linear when a change in one variable is associated with the proportional change in the other variable. The Spearman rank-order correlation may evaluate the monotonic relationship between two continuous or ordinal variables. In the monotonic relationship, the variables tend to change together, but not necessarily at a constant rate. The relationship between variables is often examined with the scatter plot where the correlation coefficients only measure linear (Pearson) or monotonic (Spearman) relationships. Both Pearson and Spearman correlation coefficients can range in value from −1 to +1 and the Pearson correlation coefficient may be +1 when one variable increases and the other variable increases by a consistent amount to form a line. The Spearman correlation coefficient is also +1 in that case.

When a relationship occurs that one variable increases when the other increases, but the amount is not consistent, the Pearson correlation coefficient is positive, but less than +1 and the Spearman coefficient still equals +1. When a relationship is random or non-existent, then both correlation coefficients are almost 0. If the relationship is a perfect line for decreasing relationship, the correlation coefficients are −1. If the relationship is that one variable decreases and the other increases, but the amount is not consistent, then the Pearson correlation coefficient is negative but greater than −1 and the Spearman coefficients still equals −1. As noted before, correlation values of −1 or 1 imply an exact linear relationship such as between a circle's radius and circumference. When two variables are correlated, it often forms a regression analysis to describe the type of relationship.

It is possible to identify the features that are used in the rule model and that are defined as transformation, combinations and ratios between variables that provide more information than they can have alone for future ranking. In order to make more informative the features, it is possible to group the variables based on the frequencies that corporate clients generate. After the feature redefinition, it may be possible to rank them in order to input the algorithm with only the most informative features. To achieve this objective, it is possible to implement a combination of feature important ranking methods such as decision trees, Chi-squared, and relief.

A decision tree may be used with various groups such as average recharges, number block and average consignment and different transfers with the gini coefficient as sometimes expressed as a gini ratio or normalized gini that is a measure of statistical dispersion that shows the inequality among values of frequency distribution.

It should also be understood that the KEO first computing system 110 may incorporate a Chi-squared test as a statistical hypothesis test where the sampling distribution of the test statistic is a Chi-squared distribution when the null hypothesis is true. The random decision force may be used as an ensemble learning method or classification, regression and constructs decision trees at training time outputting the class that is the mode of the classes. Mutual information of two random variables may be used as a measure of the mutual dependence between two variables. The analysis of variance (ANOVA) may be used as a collection of statistical models and procedures as a variation among or between groups. The observed variance in a particular variable may be petitioned into components attributable to different sources of variation. There may be some advantages of one or the other of the logistic regression over decision trees. Both are fast methodologies, but logistic regression may work better if there is a single decision boundary not necessarily parallel to the axis and decision trees may be applied to those situations where there is not just one underlying decision boundary, but many.

Approval codes for a set monetary value for the settlement card 105 and payment terms may be generated and in this example, after receiving a confirmation from the corporate client, a transaction server, or other processing system associated with the KEO first computing system 110 of the settlement card system 100 may be configured to authorize the issuance of the settlement card 105 to the corporate client having a value corresponding to the amount of the card transaction limit for that particular initial transaction, together with the settlement terms for that transaction. An acknowledgment may be received from the corporate client of the receipt of the settlement card when the settlement card 105 is a sent to the corporate client, such as a virtual card and the corporate client is electronically notified, or the corporate client could pick it up at a known location such as a card processor location such as when the settlement card is a physical card. The delivery mechanism of the settlement card can vary. When the corporate client receives the settlement card, whether virtual or physical, it acknowledges the receipt. The KEO first computing system 110 of the settlement card system 100 may have server processor capability to activate the settlement card. The settlement card 105 may be a card such as issued by a card payment service or other network such Visa, MasterCard, American Express, or another issuer.

When the settlement card 105 is delivered, the corporate client may send an acknowledgment of the receipt of the settlement card back to the first computing system 110, such as having a transaction server or other processing capability, and the response may activate the settlement card.

A risk (exposition algorithm) may control financial risk and a second algorithm, i.e., an indebtedness capacity algorithm, and may estimate the amount of money the corporate client can pay back-and-forth may be calculated for each new transaction. This can be accomplished each time a transaction is completed and new rules applied and new payment terms determined. Information that is input to these rules via an application programming interface application layer may come from different sources, including a third-party banking information provider such as a financial services data provider, a credit history, and publicly available data as noted above. The application layer may provide for further processing and possible user input. Each time a transaction is completed using the settlement card 105, new rules may be applied and a new credit score may be computed using the credit score engine followed by a request for a transaction history of financial data so that new payment terms are defined each time.

Banking data may be used to forecast corporate client monthly income, discounting the estimate of monthly charges for the corporate client if any credits had been previously taken, and may also estimate payment terms. This can be accomplished for each transaction. It is possible to quantify the exposition according to risk assessment. Bad debt likelihood is a relevant risk factor that the KEO first computing system 110 may consider and the system may calculate that using an online learning approach. For example, if terms of repayment are not met, for each day they are not met, the learning parameters of the machine learning model may be adjusted. Thus, the machine learning model becomes more accurate and available for the next transaction with each labeling.

It is also possible for the KEO first computing system 110 to consider as risk factors the income projection for a corporate client that is inferred from forecasting and information with regard to other credit products that belong to the corporate client. Public data also may be used in a parallel prediction model to infer the income and support for the repayment capacity estimation. The KEO first computing system 110 may also gather the transaction history for each corporate client banking account. Once this financial data is collected, the KEO first computing system 110 may use that financial data to improve its rule implementation.

Public data may include external information that is input as part of the repayment capacity estimate based upon each transaction, each having different repayment terms. Current banking information may be used with the risk assessment, including the income projection and miscellaneous factors and with the indebtedness capacity estimate. Past and present transaction history may be used to enhance the data and estimates, including the probability of missing the repayment terms. The credit history may be used to aid in determining default probability, which may receive information about a default prediction. Income forecasting may be used to help determine the repayment capacity estimate and income projection.

Credit history may also encompass a corporate client's past payment history or other credit and financial history of the corporate client that the KEO first computing system 110 can access. A third-party financial services data provider may send information about a corporate client's account balance, credit balance, and repayment for each past transaction in an example.

Public data may include behavior variables where a corporate client's behavior may include information about websites visited by the corporate client, product categories carried and purchased by the corporate client, ratings on e-commerce websites, the consumer or industrial segment the corporate client belongs to, and related, similar business data. Identity characteristics may be related to corporate and subsidiary addresses, location profiles of different facilities, length of residence at the locations, education level of employees and executives, their employment history and educational level. Some information may be found in LinkedIn, Facebook, Google Reviews, and similar items and automatically extracted as public data.

Corporate relationships may reveal social activity and influence within social and corporate networks and also the relationship with other companies that have similar settlement cards and that have had credit scores in the past. A user photo attribute may include other features that can be calculated or inferred by image processing of public photos of the corporate client business, e.g., found in social networks and search engines.

A feature engineering process may include two main stages, e.g., feature selection and feature extraction. In a first stage of feature selection, the KEO first computing system 110 may analyze the given data and select the most relevant features for classification. For this task, the KEO first computing system 110 may use standard methods. For example, first, filter methods may apply a statistical measure to assign a scoring to each feature and then obtain a rank. Some examples of some filter methods are the Chi squared test, information gain, and correlation coefficient scores. Wrapper methods may include those methods that consider the selection of a set of features as a search problem, where different combinations are prepared, evaluated and compared to other combinations. An example is the recursive feature elimination algorithm. Embedded methods may be related to how the KEO first computing system 110 and a machine learning module as part of a server processor or rule engine may learn which features best contribute to the accuracy of the model while the model is created. A common type of embedded feature selection methods are regularization methods.

In feature extraction, it is possible to further process data to combine features in a meaningful way or to transform them to obtain a better representation. Financial feature extraction may include a model that computes an initial score for each corporate client using banking data retrieved from the third-party financial services data provider. It may be assumed in a non-limiting example that purchases made by the settlement card 105 may be paid in a selected time period.

In a non-limiting example only, the features extracted from third-party banking information or financial services provider may include: (1) available income, which may be computed as a sum of the corporate client income, weighted by the confidence of income occurrence: [available_income]=Σ_i, income_streams_i[confidence]*income_streams_i[monthly_income], and (2) indebtedness_capacity as a prior feature about the capacity of the client to repay.

[indebtedness_capacity]=[available_income]−(1/12)*Σ[account_balance_current]−[account_balance_available], For all account type=“credit”

If a corporate client has credit products, the risk decreases because it can be assumed that a financial institution had measured risk a priori. There may be model training and model selection, and based on the obtained features, the KEO network may train the classification model. In this step, the KEO first computing system 110 attempts different classification algorithms and selects the one that best fits the business requirements. The first computing system 110 may take into account the following algorithms: 1) Linear Classifiers: Logistic Regression and Naive Bayes Classifier; 2) Support Vector Machines; 3) Decision Trees; 4) Boosted Trees; 5) Random Forest; 6) Neural Networks; and 7) Nearest Neighbor. The selection of the best model may be accomplished in a non-limiting example by evaluating the learning curves and statistical measures for fit. It may be important to take into account which model has a better impact with regard to the business objectives. If income information is not available, in another example, the KEO first computing system 110 may alternatively compute the pre-approved loan amount based on assets, assuming the account balances for the corporate client.

Income Based Pre-Approved (main)

[credit_line]=[ctrl_exposition]*[indebtedness_capacity]

Assets Based Pre-Approved (alternative)

[credit-line]=[exposition_factor]*Σ[account_balance_current] (only for depositary accounts)

### Where

[indebtedness_capacity]=[available_income]−(1/12)*Σ[account_balance_current]−[account_balance_available], For all account type=“credit”

### And

[exposition_factor]=[Delta_income]*[has_additional_credit_products]

### Predict Available Income

Available income may be computed as a sum of the corporate client income, weighted by the confidence of income occurrence:

[available_income]=Σ_i income_streams_i[confidence]*income_streams_i[monthly_income]

### Indebtedness Capacity Balance

### Measure Risk

[exposition_factor]=[ctrl_exposition]*Σw_i*[risk_factors]_I

For instance:

[exposition_factor]=[ctrl_exposition]*([trend_factor]+[credit_types_factor])

In this example, it is assumed w_i=1 for all i, hence, the sum could be greater than 1. However, it may be that Σw_i=1.

Where [ctrl_exposition] is a constant in [0,1], it is fixed as a business rule in order to set the maximum exposition.

### Risk Factors:

Income reduction or increasing. Income

[Delta_Income]=([last_year_income]−[projected_yearly_income])/[last_year_income]

[trend_factro]=1/(1+e\hat{ }(−4[Delta_Income]))

### Credit Products Balance

If a corporate client has credit products, the risk decreases since the KEO first computing system 110 may assume a financial institution had measured risk a priori.

Feature selection may also be known as variable selection and used to simplify the machine learning model and enhance processing of the processing to be more efficient and facilitate interpretation of data by corporate clients and the KEO first computing system 110. This may allow shorter training times to avoid the problems associated with dimensionality and enhanced generalization, for example, by reducing overfitting. With feature selection, the data that contains some features that are either redundant or irrelevant may be removed without incurring much loss of information. This is different from feature extraction that creates new features from functions of the original features, whereas feature selection returns a subset of the features. The KEO first computing system 110 may use a combination of search techniques for proposing new feature subsets, along with an evaluation to measure and score different feature subsets. It is possible to test each possible subset of features, finding the one that minimizes the error rate.

Based on the features obtained in the financial feature extraction such as available income, indebtedness capacity, balance risk, and other associated business data, a classification model may be trained. Different classification algorithms may be used and the algorithm that may be selected is one that may be considered the best to fit the business requirements that are taken into consideration by the KEO first computing system 110. Different algorithms may be selected as noted before, such as using linear classifiers and logistic regression and naive Bayes classifier, support vector machines, decision trees, boosted trees, random forest, neural networks, and nearest neighbor.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A settlement card system, comprising:
a settlement card issued by a card issuer, assigned a specific card customer, locked for authorized use with a single card specific merchant, and having stored settlement card data identifying a) the respective customer to which the settlement card is assigned, b) the card issuer, c) the card specific merchant, and d) a card payment service of the settlement card;
a first computing system operated by the card issuer and configured to determine a transaction monetary limit and customer payment terms that differ for each subsequent, single transaction by the customer with the card specific merchant;
a second computing system configured to receive from the card specific merchant the stored card data of the settlement card and an authorization request for approval of the transaction when the customer presents its settlement card to the card specific merchant to effect the transaction, wherein said second computing system is configured to identify the card issuer and customer from the stored card data and forward the authorization request to the first computing system, wherein the first computing system is configured to determine if the transaction is within the monetary limit determined for the customer, and if no, reject the transaction, if yes, accept the transaction and determine customer payment terms for that transaction; and
a third computing system operated by the card payment service, said third computing system configured to make payment to the authorized merchant for the transaction after receiving a payment authorization from the first computing system, and in response, the first computing system transfers a payment to the third computing system in the amount of the transaction.

2. The settlement card system of claim 1 wherein the third computing system comprises a server network operated by the card payment service.

3. The settlement card system of claim 1 wherein said first computing system comprises a plurality of servers in a cloud network forming a machine learning network as an artificial neural network.

4. The settlement card system of claim 1 wherein a customer makes payment to the first computing system for the transaction based upon payment terms determined by the first computing system for that specific, single transaction.

5. The settlement card system of claim 1 wherein said settlement card comprises a virtual settlement card.

6. A settlement card system, comprising:
a settlement card issued by a card issuer, assigned a specific card customer, locked for authorized use with a single card specific merchant, and having stored settlement card data identifying a) the respective customer to which the settlement card is assigned, b) the card issuer, c) the card specific merchant, and d) a card payment service of the settlement card;
a first computing system operated by the card issuer and configured to pull past financial transaction data and associated business data for the card customer from public and private data sources and extract customer data features as decision values, said first computing system further comprising a rules engine configured to apply a machine learning approval model as a set of rules to the decision values and determine a transaction monetary limit and customer payment terms that differ for each subsequent, single transaction by the customer with the card specific merchant;
a second computing system configured to receive from the card specific merchant the stored card data of the settlement card and an authorization request for approval of the transaction when the customer presents its settlement card to the card specific merchant to effect the transaction, wherein said second computing system is configured to identify the card issuer and customer from the stored card data and forward the authorization request to the first computing system, wherein the first computing system is configured to determine if the transaction is within the monetary limit determined for the customer, and if no, reject the transaction, if yes, accept the transaction and determine customer payment terms for that transaction;
a third computing system operated by the card payment service, said third computing system configured to make payment to the authorized merchant for the transaction after receiving a payment authorization from the first computing system, and in response, the first computing system transfers a payment to the third computing system in the amount of the transaction;
wherein said first computing system updates decision values and applies the machine learning model and a set of new rules to the updated decision values and determine a new customer monetary limit and payment terms for the subsequent, single transaction by the customer.

7. The settlement card system of claim 6 wherein the third computing system comprises a server network operated by the card payment service.

8. The settlement card system of claim 6 wherein the rules engine comprises a reasoner inference engine that optimizes each set of new rules by applying a forward chaining model to the decision values based upon new inferences and applying an expert system as a backward chaining model to the decision values.

9. The settlement card system of claim 8 wherein the reasoner inference engine establishes a syntax tree for each set of new rules.

10. The settlement card system of claim 9 wherein the first computing system comprises at least one cache configured to cache the syntax tree that is updated each time the first computing system applies the machine learning approval model and set of new rules to updated decision values.

11. The settlement card system of claim 6 wherein said associated business data for the customer comprise a) behavior variables related to business transactions of the customer, b) social characteristics of the customer when interacting with the public, and c) business relationships of the customer with different companies.

12. The settlement card system of claim 6 wherein said first computing system comprises a plurality of servers in a cloud network forming a machine learning network as an artificial neural network.

13. The settlement card system of claim 6 wherein said first computing system comprises a non-relational database that stores business rules parameterized in a structured JSON file.

14. The settlement card system of claim 13 wherein said non-relational database is mounted on a database hosting service.

15. The settlement card system of claim 6 wherein said customer makes payment to the first computing system for the transaction based upon payment terms determined by the first computing system for that specific, single transaction.

16. The settlement card system of claim 6 wherein said settlement card comprises a virtual settlement card.

17. A settlement card system, comprising:
a settlement card issued by a card issuer, assigned a specific card customer, locked for authorized use with a single card specific merchant, and having stored settlement card data identifying a) the respective customer to which the settlement card is assigned, b) the card issuer, c) the card specific merchant, and d) a card payment service of the settlement card;
a first computing system operated by the card issuer and configured to pull past financial transaction data and associated business data for the card customer from public and private data sources and extract customer data features as decision values, said associated business data for the customer comprising a) behavior variables related to business transactions of the customer, b) social characteristics of the customer when interacting with the public, and c) business relationships of the customer with different companies, said first computing system further comprising a rules engine configured to apply a machine learning approval model as a set of rules to the decision values, said rules engine including a reasoner inference engine configured to optimize each set of new rules by applying a forward chaining model to the decision values based upon new inferences and applying an expert system as a backward chaining model to the decision values and determine a transaction monetary limit and customer payment terms that differ for each subsequent, single transaction by the customer with the card specific merchant;
a second computing system configured to receive from the card specific merchant the stored card data of the settlement card and an authorization request for approval of the transaction when the customer presents its settlement card to the card specific merchant to effect the transaction, wherein said second computing system is configured to identify the card issuer and customer from the stored card data and forward the authorization request to the first computing system, wherein the first computing system is configured to determine if the transaction is within the monetary limit determined for the customer, and if no, reject the transaction, if yes, accept the transaction and determine customer payment terms for that transaction;
a third computing system comprising a server network operated by the card payment service, said third computing system configured to make payment to the authorized merchant for the transaction after receiving a payment authorization from the first computing system, and in response, the first computing system transfers a payment to the third computing system in the amount of the transaction;
wherein said first computing system updates decision values and applies the machine learning model and a set of new rules to the updated decision values and determine a new customer monetary limit and payment terms for the subsequent, single transaction by the customer.

18. The settlement card system of claim 17 wherein the reasoner inference engine establishes a syntax tree for each set of new rules, and said first computing system comprises at least one cache configured to cache the syntax tree that is updated each time the first computing system applies the machine learning approval model and set of new rules to updated decision values.

19. The settlement card system of claim 17 wherein said first computing system comprises a plurality of servers in a cloud network forming a machine learning network as an artificial neural network.

20. The settlement card system of claim 17 wherein said customer makes payment to the first computing system for the transaction based upon payment terms determined by the first computing system for that specific, single transaction.

21. The settlement card system of claim 17 wherein said settlement card comprises a virtual settlement card.
